(19) United States
(12) Patent Application Publication
(10) Pub. No.: US 2007/0074116 A1
(43) Pub. Date: Mar. 29, 2007

(54) Multi-pane navigation/synchronization in a multimedia presentation system

(75) Inventor: Pavithran D. Thomas, Orlando, FL (US)

Correspondence Address: Adam E. Crall - Carlton Fields, P.A., P.O. Box 3239, Tampa, FL, 33601-3239, US

(73) Assignee: Teleios, Inc.

(21) Appl. No.: 11/238,377

(22) Filed: Sep. 29, 2005

(51) Int. Cl. G11B 27/00

(52) U.S. Cl. 715/719

(57) ABSTRACT

Various computer systems, methods, and computer software for supporting multi-pane navigation/synchronization in a multimedia presentation system are provided. One embodiment comprises a method for presenting a multimedia presentation in an interactive user interface. One such method comprises: presenting a multimedia program in a first pane, a second pane, and a third pane of a user interface, the first pane for presenting video data associated with the multimedia program, the second pane for presenting an outline of the multimedia program, and the third pane for presenting a transcript of the video data; and enabling a user to synchronously navigate the multimedia program from each of the transcript pane, the video pane, and the outline pane.

### BACKGROUND

Multimedia generally refers to the combined use of different kinds of communication media in computer systems, software, and networks. For instance, multimedia generally includes any of the following or other types of communication media: text, images, graphics, audio, moving pictures, video, and the like. Computer systems are typically configured to present any of these types of communication media to a computer end user via a graphical user interface and an accompanying display device. The content and/or functionality associated with the multimedia presentation system is oftentimes provided to an end user computer device via another computer system connected to a computer network.

Depending on the particular use, application, design, etc., the computer system, computer software, and/or computer network may be configured to support various forms of user interaction with the multimedia presented via the graphical user interface. For instance, many multimedia presentation systems include various user interface controls for enabling the computer end user to navigate the multimedia contact. Audio and/or video presentation software is typically integrated with a control panel that enables the computer end user to fast-forward, rewind, stop, and pause the content. Text-based systems often include various text search tools which enable the end user to find certain words within the presented text or navigate within the text with page-up, page-down, next slide, or previous slide commands, vertical scroll functionality, and the like. The ubiquitous web browser includes various forms of user interface controls for interacting with the displayed content, as well as searching for various on-line resources.

### SUMMARY

Various computer systems, methods, and computer software for supporting multi-pane navigation/synchronization in a multimedia presentation system are provided. One embodiment is a computer system for presenting a multimedia program to a user via a user interface. One such computer system comprises: a video pane for presenting a video portion of a multimedia program on a first portion of a user interface; a transcript pane for presenting a transcript of the video portion on a second portion of the user interface; an outline pane for presenting an outline of the multimedia program on a third portion of the user interface; and a presentation synchronization functionality configured to synchronously present the video portion, the transcript, and the outline.

Another embodiment is a method for presenting a multimedia program to a user via a graphical user interface. One such method comprises: receiving a multimedia program comprising a video portion, a transcript of the video portion, and an outline of the multimedia program; and synchronously presenting the video portion, the transcript, and the outline in respective panes of a user interface.

A further embodiment is a multimedia presentation embodied in a computer-readable medium and configured for presentation to a user via a graphical user interface. One such multimedia presentation comprises: media data; and a transcript of the media data comprising: a plurality of outline elements defining an outline schema associated with the content of the media data; and a plurality of timestamps synchronized to the corresponding portions of the media data.

A method for creating a multimedia presentation, the method comprising: providing audio data of an oral presentation; generating a transcript of the oral presentation; generating an outline of the oral presentation; and synchronizing the transcript, the outline, and the audio data for simultaneous presentation in a transcript pane, an outline pane, and an audio pane of a user interface.

A method for presenting a multimedia presentation in an interactive user interface, the method comprising: presenting a multimedia program in a first pane, a second pane, and a third pane of a user interface, the first pane for presenting video data associated with the multimedia program, the second pane for presenting an outline of the multimedia program, and the third pane for presenting a transcript of the video data; and enabling a user to synchronously navigate the multimedia program from each of the transcript pane, the video pane, and the outline pane.

A computer system for presenting a multimedia program, the computer system comprising: a user interface comprising: a video pane for presenting a video portion of a multimedia program; a transcript pane for presenting a transcript of the video portion; and an outline pane for presenting an outline of the multimedia program; and a multi-pane navigation/synchronization framework configured to enable a user to synchronously navigate the multimedia program via at least one of the transcript pane, the video pane, and the outline pane.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is a block diagram illustrating an embodiment of a multi-pane navigation/synchronization framework (MNSF) for a multimedia presentation system.

FIG. 2 is a flow chart illustrating the architecture, operation, and/or functionality of an embodiment of the MNSF of FIG. 1.

FIG. 3 is a block diagram illustrating the logical data structure for an embodiment of an integrated multimedia program to be presented using the MNSF of FIGS. 1 and 2.

FIG. 4 is a combined flow/block diagram illustrating the architecture, operation, and/or functionality of another embodiment of the MNSF of FIGS. 1 and 2 from the perspective of a user interface console.

FIG. 5 is a screen shot illustrating an embodiment of the user interface console of FIG. 4.

FIG. 6 is a screen shot illustrating another embodiment of a user interface console for implementing various aspects of the MNSF of FIGS. 1 and 2.

FIG. 7 is a screen shot of the user interface console of FIG. 6 illustrating an embodiment of an A/V navigation mechanism associated with the A/V pane.

FIG. 8 is a screen shot of the user interface console of FIG. 6 illustrating an embodiment of an outline navigation mechanism associated with the outline pane.

FIG. 9 is a screen shot of the user interface console of FIG. 6 illustrating a transcript framing feature of the transcript pane.

FIG. 10 is a screen shot of the user interface console of FIG. 6 illustrating an embodiment of a transcript navigation mechanism associated with the transcript pane.

FIG. 11 is a screen shot of the user interface console of FIG. 6 illustrating an embodiment of link mechanism between the transcript pane and the resource pane.

FIGS. 12 & 13 are screen shots of the user interface console of FIG. 6 illustrating a database look-up feature in the resource pane.

FIG. 14 is a screen shot of the user interface console of FIG. 6 illustrating the results of a database look-up in the resource pane.

FIG. 15 is a screen shot of the user interface console of FIG. 6 illustrating a user login screen for accessing an on-line resource portal.

FIGS. 16-19 are screen shots of the user interface console of FIG. 6 illustrating a search facility in the resource pane.

FIG. 20 & 21 are screen shots of the user interface console of FIG. 6 illustrating a notes pane.

FIG. 22 is a screen shot of the user interface console of FIG. 6 illustrating a save transcript feature.

FIG. 23 is a screen shot of the user interface console of FIG. 6 illustrating an HTML version of the transcript.

FIG. 24 is a screen shot of the user interface console of FIG. 6 illustrating a transcript search feature.

FIGS. 25-28 are screen shots of the user interface console of FIG. 6 illustrating various menu options.

FIGS. 29 & 30 are screen shots of the user interface console of FIG. 6 illustrating an audio export feature.

FIG. 31 is a block diagram illustrating the logical data structure for another embodiment of an integrated multimedia program to be presented using the MNSF of FIGS. 1 and 2.

FIG. 32 is a block diagram illustrating an embodiment of a content distribution system in which an MNSF may be implemented.

### DETAILED DESCRIPTION

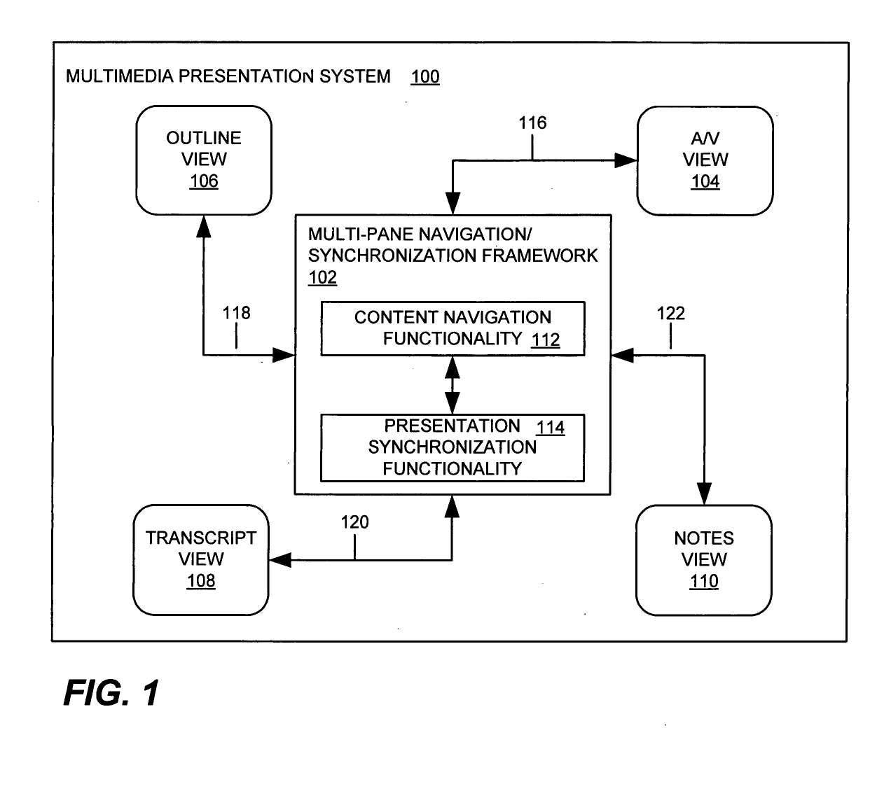

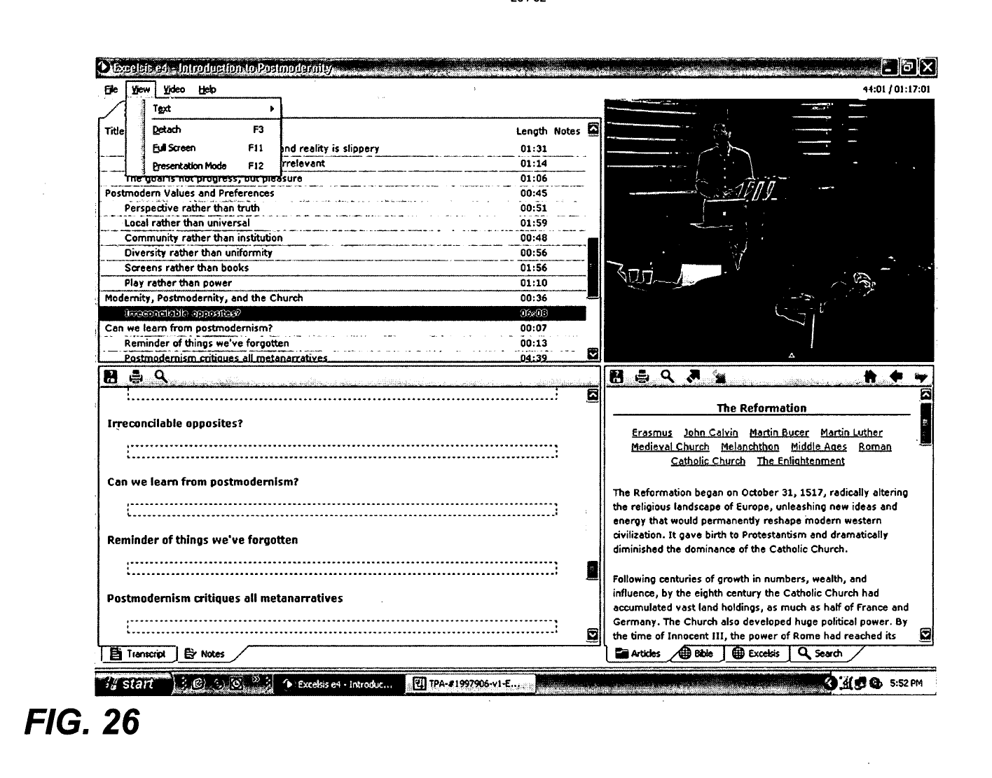

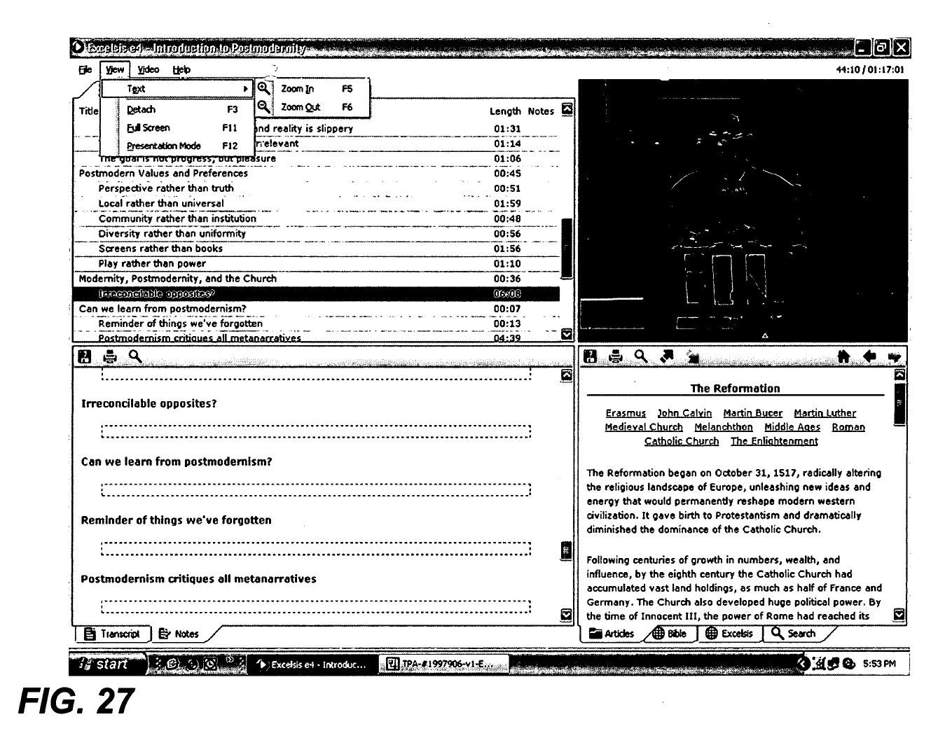

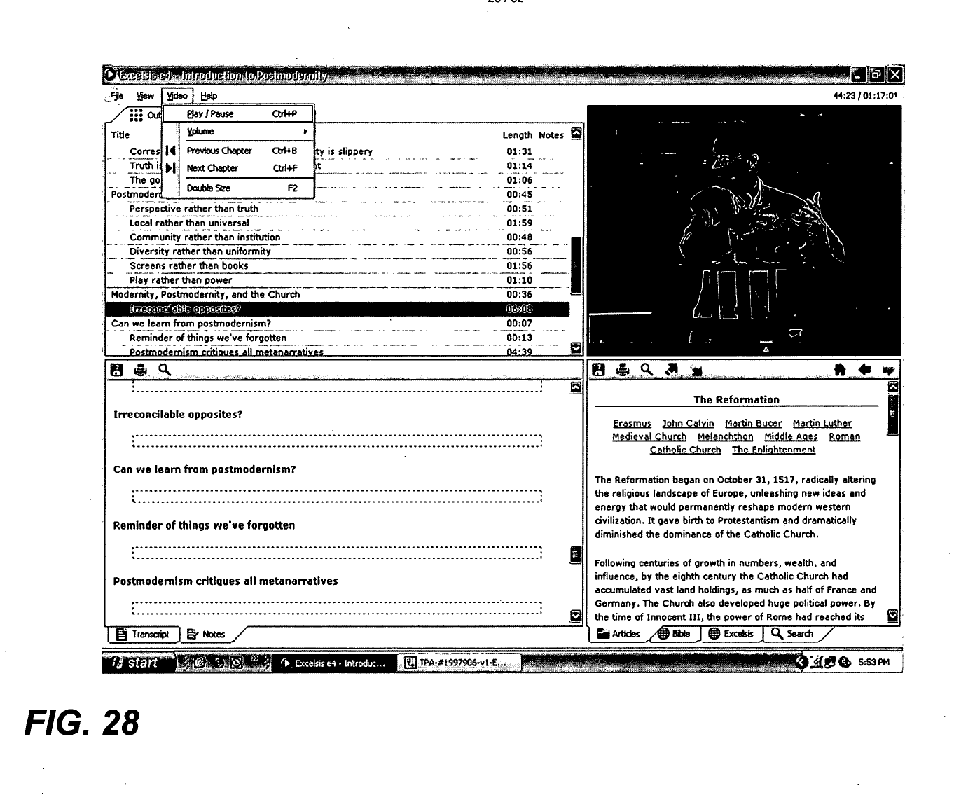

This disclosure relates to various computer systems, methods, and computer software for supporting multi-pane navigation/synchronization in a multimedia presentation system. Various embodiments of systems, methods, and computer software for supporting multi-pane navigation/synchronization in a multimedia presentation system are described below with respect to FIGS. 1-32. As an introductory matter, however, the general architecture, operation, and/or functionality of an embodiment of a multimedia presentation system will be briefly described. Although this embodiment is described in terms of an educational framework, it should be appreciated that the underlying architecture and functionality may be implemented in various applications, uses, etc. Furthermore, it should be appreciated that the multimedia presentation may implement various types of multimedia content depending on the particular application or use.

The exemplary educational framework comprises computer-implemented systems, methods, and computer software for capturing a live educational event, producing a multimedia presentation based on the live event, and presenting the multimedia experience to users via desktop and/or web-based software. The overall conceptual flow of the educational framework involves: (1) capturing audio/visual from the educational event; (2) performing post-production processes on the audio/visual content; (3) generating a transcript of the educational event; (4) generating an outline of the educational event; (5) synchronizing the outline, the transcript, and the audio/visual content; and (6) simultaneously presenting the synchronized outline, transcript and audio/visual content to an end user in separate panes of a user interface console supported by the desktop and/or web-based software.

The user interface console enables the end user to simultaneously view the audio/visual content of the educational event in one pane (i.e., video pane), the transcript of the educational event in a second pane (i.e., transcript pane), and the text outline of the educational event in a third pane (i.e., outline pane). The transcript may be generated by a computer-implemented transcription mechanism, such as, for example, a voice recognition functionality, or by a manual process. The transcript may be enriched with embedded hyperlinks to additional educational resources, which may be presented in a fourth pane which is simultaneously displayed with the other three panes (i.e., a resource pane). For example, the transcript and/or the outline of the educational event may include a word or phrase associated with a particular topic of interest. The word or phrase may be linked to additional resources (e.g., articles, definitions, search engines, on-line or local databases, etc.). In this manner, the end user may select the particular word or phrase in the transcript pane (or the outline pane), and additional resources will be provided to the end user in the resource pane.

The audio/visual content, the transcript, and the outline are synchronously presented in the corresponding panes. In other words, as the audio/visual is played in the video pane, the corresponding content is displayed in the transcript pane and the outline pane, so that the end user may follow along with the content in the transcript and outline panes. The audio/visual content, the transcript, and the outline are also tightly integrated with user interface controls for enabling the end user to navigate the content in one pane, while maintaining the synchronized presentation of the corresponding content in each of the other panes. For example, when the end user moves forward or backward in the video pane (or otherwise interacts with the audio/visual content) via a video navigation tool, the content in the outline and transcript panes is automatically updated. If the user fast-forwards the video to a new topic, the content displayed in the outline pane and the transcript pane is automatically updated to the corresponding point in time. The navigation/synchronization occurs between all of the panes. In this regard, the multi-pane navigation/synchronization functionality combines a layer of user control across each of the panes with a layer of synchronized presentation within each of the panes.

The end user may navigate within any of the panes (not just the video pane), and the content in the other panes is automatically updated. For instance, when the user selects a particular topic in the outline pane, the corresponding content in the transcript pane is updated, and the audio/visual content is moved forward/backward in time to the corresponding portion of the educational event in the video pane.

The user interface console may also include a notepad feature for enabling the end user to take notes. The notepad may be integrated with the transcript pane as, for example, an alternative tab which enables the end user to switch between a transcript tab and a notes tab. While interacting with the multimedia presentation via the other panes, the end user may enter notes, reflections, etc. into the notepad. The end user's notes may be linked or integrated with the content in the outline pane and/or the transcript panes, and stored for subsequent retrieval, on-line sharing, etc. The note pad functionality may support an automated note annotation feature whereby a user's notes are automatically annotated with hyperlinks to associated resources. The automated note annotation feature compares the text of the notes entered by the end user to words, phrases, topics, etc. stored as part of the resources. If a match occurs, the notes are automatically annotated as a link (e.g., a hypertext link) to the corresponding resources in the resource pane.

Having described one exemplary implementation of a multi-pane navigation/synchronization functionality within an educational framework, various additional embodiments will be described with respect to FIGS. 1-32.

FIG. 1 illustrates a multimedia presentation system 100 which implements a multi-pane navigation/synchronization framework (MNSF) 102. Multimedia presentation system 100 supports a number of different views within a graphical user interface. Each view is used to display a different aspect or portion of an integrated multimedia presentation or program (and/or accompanying functions, features, and resources). For instance, in the embodiment illustrated in FIG. 1, the multimedia program comprises audio/video (A/V) data, an outline associated with the content of the A/V data, and a transcript of the A/V data.

Multimedia presentation system 100 presents the A/V data via an A/V view 104 of a related graphical user interface. The outline associated with the A/V data and transcript of the A/V data are presented via an outline view 106 and transcript view 108, respectively. As further illustrated in FIG. 1, multimedia presentation system 100 may present a notes view 110 which enables the end user to spontaneously record notes, reflections, and the like, while interacting with the multimedia program.

It should be appreciated that multimedia presentation system 100 may support additional views for providing various other features and functionality. The additional views may be simultaneously displayed with A/V view 104, outline view 106, transcript view 108, or notes view 110. Or, in alternative embodiments, the additional views may be integrated with or accessed from views 104, 106, 108, and/or 110. An example of an additional view is a resources view for providing various additional research facilities and resources to the end user. Various tools may be provided via the resources view. For example, as described in more detail below, in one embodiment, the transcript, the outline, and/or the notepad may be enriched with embedded links to resources presented via the resources view. The transcript, the outline, and/or the user notes of the multimedia program may include a word or phrase associated with a particular topic of interest. The word or phrase may be linked to additional resources (e.g., articles, definitions, search engines, on-line or local databases, etc.). The end user may select the particular word or phrase via the particular view, and additional resources will be provided to the end user in the resource pane. In the case of the user notes, the word or phrase may be automatically linked to the resources as the user enters the text into a notepad functionality.

Although referred to as A/V data, it should be appreciated that the data may comprise audio only, video only, or any combination thereof. In one embodiment, the A/V data may be captured from a live event (e.g., a class room lecture, seminar, etc.). In this regard, the A/V data may be captured from a number of different sources, including, but not limited to, microphones, cameras, overhead projectors, electronic whiteboards, and computers. The A/V data may capture various camera angles of the live event, such as, the presenters), the audience, and materials accompanying the live event. After capture, the A/V data may undergo various post-production processes to generate suitable multimedia file(s). The post-production processes may involve, for instance, enhancement processes, data compression algorithms, or any other desirable editing process. If the A/V data is captured in analog form, it may be converted to digital form for subsequent processing. Furthermore, it should be appreciated that the A/V data may include various graphics, images, etc. which are integrated with the audio/video.

The transcript presented in view 108 comprises a text representation of portion(s) or all of the verbal content of the A/V data. The transcript may be manually generated by a word processing technician or automatically generated via a voice recognition functionality.

The outline comprises the main points or topics of the subject matter of the A/V data and/or the transcript. In one embodiment, the outline may be structured as a one-dimensional list of topical headings, while other embodiments may incorporate any desirable hierarchical structure of outline elements (e.g., I, IA, IB, II, IIA, IIB1, IIB2i, IIB2ii, etc.) to represent the content. The structure and/or content of the outline may be manually generated by a skilled technician, although automated means may be employed where desirable or practical. The transcript may be annotated with the outline elements or headings. As described in more detail below, the outline may be presented in outline view 106 as a menu which is linked to the A/V data and the transcript, and allows for intuitive navigation through the A/V material. One of ordinary skill in the art will appreciate that outline view 106 may lessen the need for note-taking by the end user which is nothing more than a re-encapsulation of the material. Therefore, while interacting with the multimedia program, the end user may have more flexibility and freedom to think creatively and intuitively about the content.

Referring again to FIG. 1, MNSF 102 logically interfaces with A/V view 104, outline view 106, transcript view 108, and resources view 110 via interfaces 116, 118, 120, and 122, respectively. As illustrated in FIG. 1, MNSF 102 comprises two main components: (1) a content navigation functionality 112; and (2) a presentation synchronization functionality 114. In general, content navigation functionality 112 comprises logic configured to respond to user navigation commands from one or more of views 104, 106, 108, and 110. In this regard, it should be appreciated that one or more of the views may include a control layer for enabling the end user to navigate the content of the multimedia program.

A/V view 104 may include a media player-type functionality which enables the end user to fast-forward, reverse, pause, stop, or otherwise control the playback of the A/V data. The outline presented in outline view 106 may be configured as a menu linked to the A/V data and/or transcript. For example, the outline elements may be configured as links, so that, when a user “selects” a particular element, the transcript and the A/V data are updated to the corresponding temporal location. As mentioned above, the transcript may be encapsulated by, or annotated with, the outline content. In this manner, the end user may select the outline elements within transcript view 108 and navigate the content. Transcript view 108 and outline view 106 may include other control layers to enable the end user to navigate the content. Transcript view 108 may include, for example, text scroll bars, a term search function, or a next/previous-element functionality, to name a few.

Content navigation functionality 112 interfaces with the respective control/navigation functionalities in A/V view 104, outline view 106, transcript view 108, and resources view 110 to determine whether the end user has initiated a navigation command (e.g., move to next outline element, fast-forward 30 seconds, move to next occurrence of term “x”).

In general, presentation synchronization functionality 114 comprises the logic for maintaining a synchronous presentation of content within A/V view 104, outline 106, transcript view 108, and resources view 110—based on the user navigation commands received by content navigation functionality 112.

It should be appreciated that MNSF 102, content navigation functionality 112, and presentation synchronization functionality 114 may be implemented in software, hardware, firmware, or a combination thereof. Accordingly, in one embodiment, MNSF 102 is implemented in software or firmware that is stored in a memory and that is executed by a suitable instruction execution system. In software embodiments, MNSF functionality 102 may be written in any computer language.

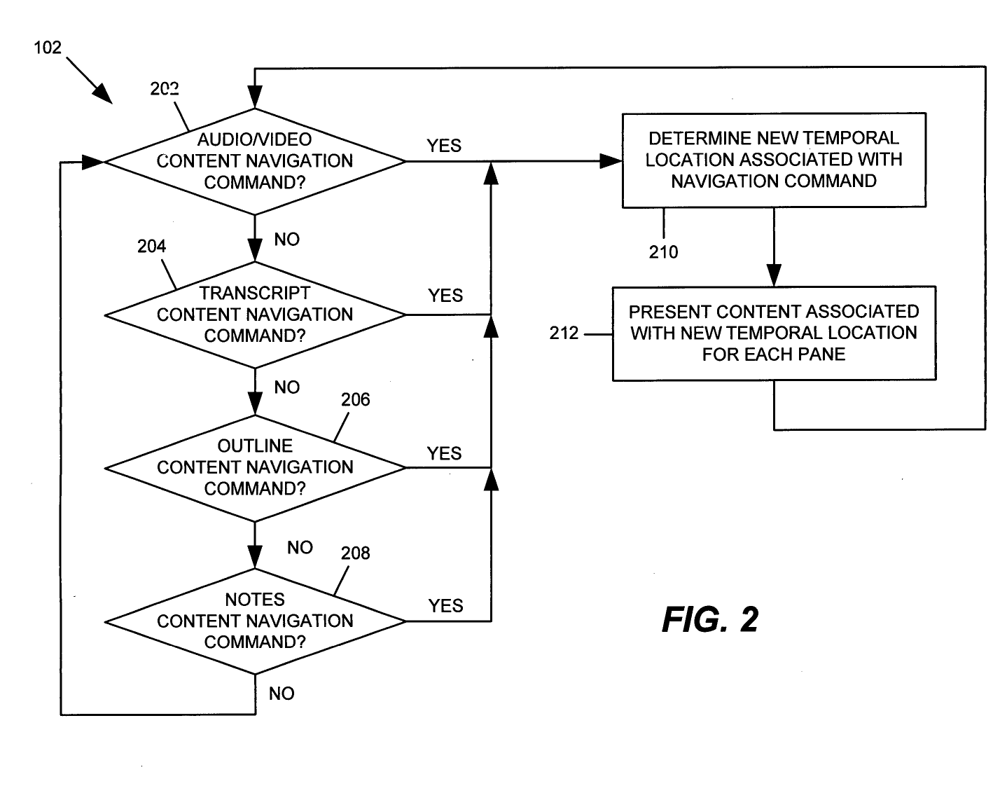

FIG. 2 illustrates the architecture, operation, and/or functionality of an implementation of MSNF 102 and the accompanying functionality 112 and 114. At block 202, content navigation functionality 112 determines whether the end user has initiated a navigation command associated with A/V view 104. At block 204, content navigation functionality 112 determines whether the end user has initiated a navigation command associated with the transcript view 108. At block 206, content navigation functionality 112 determines whether the end user has initiated a navigation command associated with the outline view 106. At block 208, content navigation functionality 112 determines whether the end user has initiated a navigation command associated with notes view 110.

If content navigation module 112 receives a navigation command initiated via one of the views, at block 210, presentation synchronization functionality 114 determines the target temporal location corresponding to the command. For example, the end user may desire to move to a new portion of the multimedia program. Within outline view 106, for example, the end user may select a particular outline heading which is linked to a corresponding temporal location of the multimedia program (e.g., via a time stamp). Based on the navigation command received, presentation synchronization module 114 may determine the new temporal location. At block 212, presentation synchronization module 114 updates the content presented in each view to be synchronized to the new temporal location within the multimedia program.

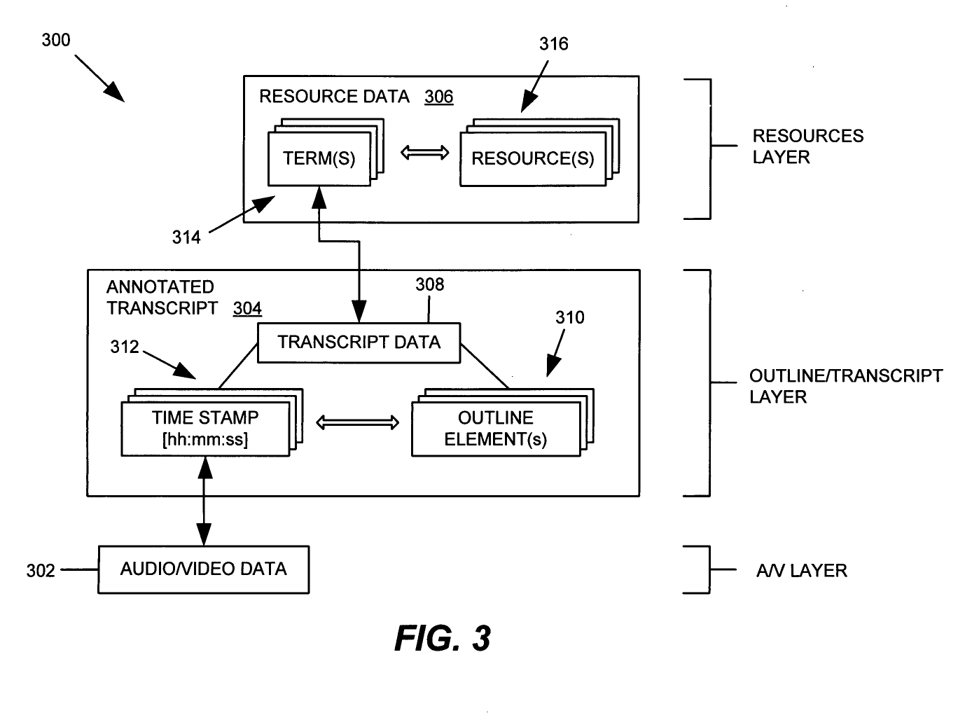

MNSF 102 may be used with various types of multimedia programs. FIG. 3 illustrates the logical data structure for one of a number of possible embodiments of an integrated multimedia program 300. Integrated multimedia program 300 comprises three integrated data layers: (1) an A/V layer; (2) an outline/transcript layer; and (3) a resources layer. As illustrated in FIG. 3, the A/V layer comprises A/V data 302 which defines the backbone of the multimedia program or, in a sense, the main material or content. As mentioned above, A/V data 302 may comprise audio and video associated with a captured live event, as well as any other graphics, images, etc.

The outline/transcript layer includes transcript data 308 which comprises the audio/verbal data converted to text format. Transcript data 308 is annotated with time stamp data 312 and outline element(s) 310 to define an annotated transcript 304. Time stamp data 312 comprises a plurality of timestamps which define a corresponding temporal location relative to A/V data 302. As illustrated in FIG. 3, the time stamps link an outline element 310 (or other term(s)) in transcript data 308 to a corresponding temporal location relative to A/V data 302. For example, A/V data 302 may comprise a 60-minute video lecture, ranging from [00:00:00] to [00:60:00]. Time stamp data 312 may be used to link outline element(s) 310 or other terms in transcript data 308 to a corresponding location in A/V data 302. Assuming that a new outline topic begins twenty three minutes and 19 seconds into the lecture, annotated transcript 304 time stamps the outline element with [00:23:19].

The resources layer comprises resource data 306 associated with the content of the multimedia program. Resource data 306 comprises an index of terms 314 located in transcript data 308, which are matched to related resources (e.g., articles, definitions, and documents). Resources 316 may be manually selected based on particular terms of interest. Alternatively, resources 316 may be determined by a search facility, either local or remote.

Referring to FIG. 3, annotated transcript 304 functions as the “temporal glue” for synchronizing the presentation of content in A/V view 104, outline view 106, transcript view 108, and resources view 110. Transcript data 308 is temporally linked to A/V data 302 by time stamp data 312, and transcript data 308 is logically linked to resources 316 via the term index. Transcript data 308 is temporally linked to A/V data 302 by time stamp data 312. Transcript data 308 is also linked to the outline because it is encapsulated by, or annotated with, outline element(s) 310. In this manner, annotated transcript 304 tightly integrates (in a temporal sense) A/V view 104, outline view 106, transcript view 108, and resources view 110.

It should be appreciated that annotated transcript 304 may be configured in a number of ways. In one embodiment, annotated transcript 304 is encapsulated and annotated in a proprietary XML schema, as illustrated in Tables 1 and 2 below.

TABLE 1
TRANSCRIPT SCHEMA

```
        <?xml version=“1.0” ?>
        <!DOCTYPE xs:schema (View Source for full doctype...)>
- <xs:schema targetNamespace=“http://www.w3.org/2001/XMLSchema-instance”
        xmlns:xs=“http://www.w3.org/2001/XMLSchema”
        xmlns=“http://www.w3.org/1999/xhtml” finalDefault=“” blockDefault=“”
        elementFormDefault=“unqualified” attributeFormDefault=“unqualified”>
- <xs:annotation>
- <xs:documentation>
    <h1>XML Schema instance namespace</h1>
- <p>
        See
    <a href=“http://www.w3.org/TR/xmlschema-1/”>the XML Schema
        Recommendation</a>
        for an introduction
        </p>
    <hr />
        $Date: 2001/03/16 20:25:57 $
    <br />
        $Id: XMLSchema-instance.xsd,v 1.4 2001/03/16 20:25:57 ht Exp $
        </xs:documentation>
        </xs:annotation>
- <xs:annotation>
- <xs:documentation>
- <p>
        This schema should never be used as such:
    <a href=“http://www.w3.org/TR/xmlschema-1/#no-xsi”>the XML Schema
        Recommendation</a>
        forbids the declaration of attributes in this namespace
        </p>
        </xs:documentation>
    </xs:annotation>
    <xs:attribute name=“nil” />
    <xs:attribute name=“type” />
    <xs:attribute name=“schemaLocation” />
    <xs:attribute name=“noNamespaceSchemaLocation” />
        </xs:schema>
```

TABLE 2
TRANSCRIPT SCHEMA

```
<?xml version=“1.0” encoding=“UTF-8” ?>
- <outlinedTranscript xmlns:xsi=“http://www.w3.org/2001/XMLSchema-instance”
        xsi:noNamespaceSchemaLocation=“sourceoutliner.xsd”>
- <head>
- <sessionInfo>
    <event title=“The Provocative Church” where=“Orlando, FL” when=“Summer
        2003” type=“Lecture” />
    <onDay>2</onDay>
    <sessionNumber>9</sessionNumber>
    <sessionTitle>Metanarrative</sessionTitle>
    <speaker who=“Graham Tomlin” role=“Primary Equipper” />
    <moreInfo name=“note”>The Provocative Church</moreInfo>
        </sessionInfo>
- <docInfo>
    <transcription who=“Faith Hopler” when=“” team=“” />
    <revision who=“Faith Hopler” when=“” team=“” />
    <revision who=“Faith Hopler” when=“July 4, 2005” team=“Teleios”>Fixed all
        scriptureLinks - put in final form. All references linked; extraneous links
        removed.</revision>
    <revision who=“Faith Hopler” when=“July 13, 2005” team=“Teleios”>Took out
        book-name-only scriptureLinks</revision>
    <moreInfo
        name=“sessionID”>cc.teleios.2003.ProvocativeChurch.en.01.09</moreInfo>
    <moreInfo name=“unitTitle”>01 The Provocative Church</moreInfo>
    <moreInfo name=“courseID”>cc.teleios.2005.Sampler.en.01</moreInfo>
        </docInfo>
        </head>
- <body>
- <outline title=“Introduction” timeStampStart=“20”>
- <content>
    <p>Good, OK. Well, let's get moving into our next section.</p>
    <p>And what we're doing this afternoon is, we really are getting into some
        fairly serious biblical work, biblical theology to try and see how we go about
        addressing some of the issues we talked of already this morning. We talked
        about the kind of issues that are going to be important to build provocative
        churches, as we've talked about them.</p>
    <p>But we are starting to do some serious work with the text of Scripture now.
        And I want to do that...</p>
        </content>
        </outline>
- <outline title=“Scripture's Role in Christian Identity” timeStampStart=“19460”>
- <content>
    <p>And we come to this point in a sense after the study of culture but that
        isn't by any means to say that this comes as a second step to the study of
        culture. We want to remember that the thing that keeps us Christian is
        Scripture. Scripture is the thing that keeps us in terms of our own identity
        close to where we are meant to be.</p>
- <p>
        We need to take the story of Scripture as our basic text for understanding
        who we are, rather than the story of
    <uriLink
        uri=“postmodernity.xhtml?subject=Postmodernity”>postmodernism</uriLink
        >
        or science or politics or
    <uriLink uri=“modernism.xhtml?subject=Modernism”>modernism</uriLink>
        or sociology or psychology or any other story. It's important to read those
        things, it's important to understand context, but those are contexts and
        culture, but those can never be the story that tells us who we are. It is
        Scripture that does that. This is the story that we trust and believe and
        through which we interpret the world.
        </p>
    <p>And so it's vital that we do this work of looking at the biblical story, and
        seeing what this has to say to us today.</p>
    <p>So let's just think. What I'm going to try to do is take a very quick sweep
        through the whole of Scripture and see where we go with this.</p>
        </content>
        </outline>
```

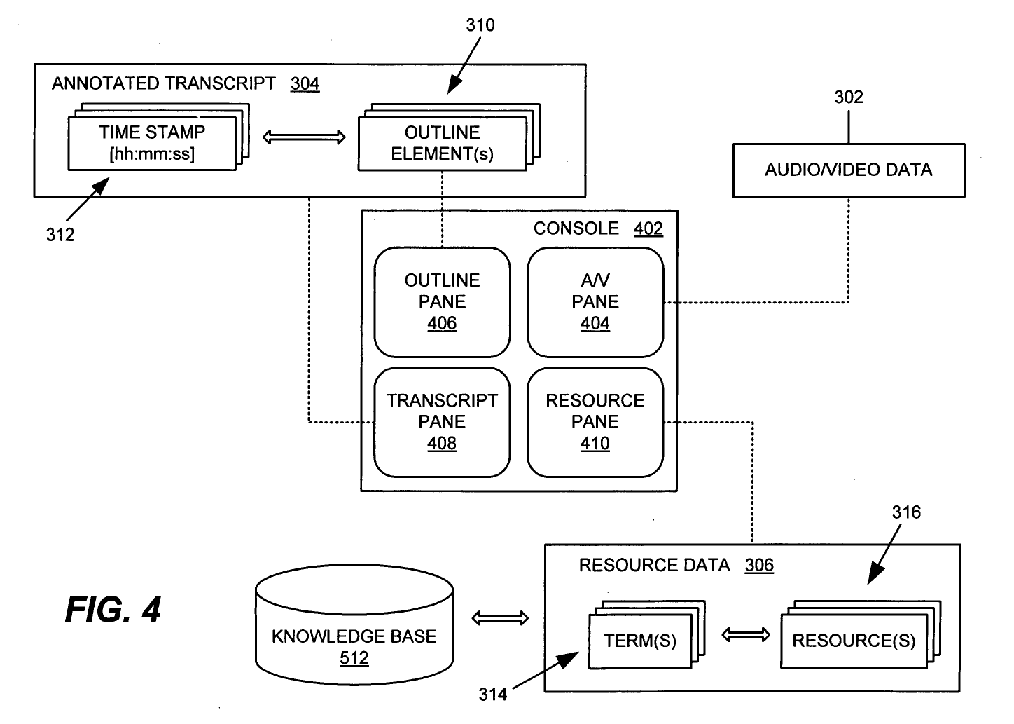

FIG. 4 illustrates another implementation of MNSF 102 from the perspective of the user interface (e.g., user interface console 402). As mentioned above, MNSF 102 synchronously presents the A/V data, the transcript, the outline, and the resources in the user interface. In this regard, user interface console 402 comprises four simultaneously-displayed panes or windows: A/V pane 404 for presenting A/V data 302; outline pane 406 for presenting the outline (e.g., outline elements 310); transcript pane 408 for presenting transcript data 308; and resources pane 410 for providing resources 316. As represented by the dotted lines in FIG. 4, the end user views and interacts with A/V data 302 via A/V pane 404. The end user-views and interacts with the outline (outline elements 310) via outline pane 406. The end user views and interacts with the transcript (annotated transcript 304) via transcript pane 408. Resource pane 410 provides the interface to resource data 306 and knowledge base 512.

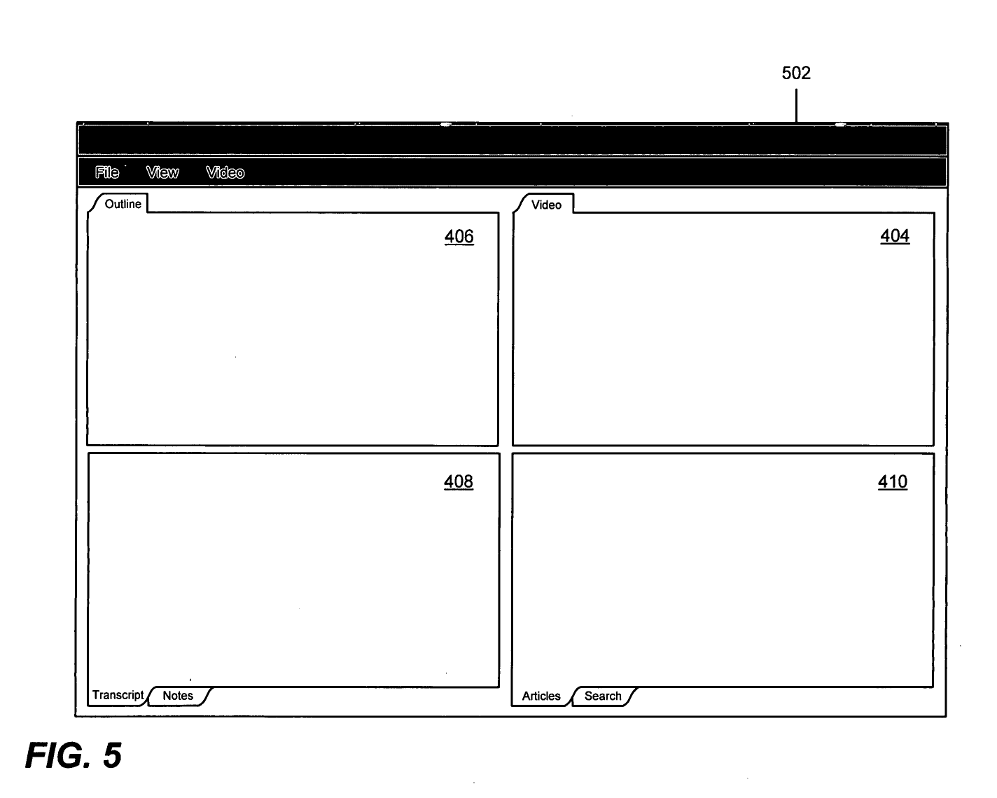

A further description of the architecture, operation, and/or functionality of embodiments of MNSF 102 (from the perspective of the computer end user) will be provided with reference to the user interface screen shots of FIGS. 5-30. FIG. 5 illustrates a simplified screen shot of one embodiment of a user interface for implementing certain aspects of MNSF 102. As illustrated in FIG. 5, the user interface displays a presentation window 502 from which a computer end user may access a multimedia program. Presentation window 502 comprises A/V pane 404, outline pane 406, transcript pane 408, and resources pane 410. Additional panes or views may be accessed via alternative tabs. For example, in the embodiment illustrated in FIG. 5, transcript pane 408 includes an associated “notes” tab for accessing the notepad functionality described above. Resource pane 410 includes an “articles” tab which displays any applicable resources 316, and a “search” tab provides a launching point for enabling the end user to initiate manual searches of knowledge base 512.

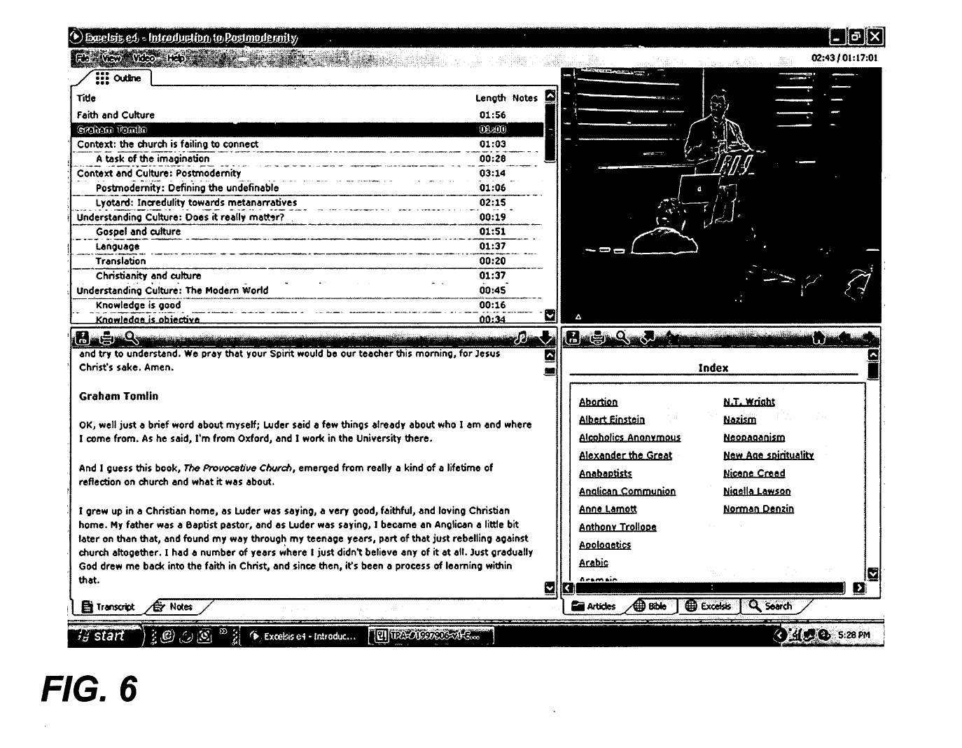

The user interface screen shots of FIGS. 6-30 illustrate various additional features and elements of alternative embodiments of MNSF 102—again, from the perspective of the computer end user. The user interface of FIGS. 6-30 is arranged in a manner similar to user interface console 402 (FIG. 4), with the A/V pane in the upper right portion of the screen, the outline pane in the upper left portion of the screen, the transcript pane in the lower left portion of the screen, and the resources pane in the lower right portion of the screen. With respect to the embodiment of FIGS. 6-30, however, additional features and elements will be described.

The outline pane comprises a vertical list of outline elements which define the outline. The outline pane includes a vertical scroll bar for navigating up and down the list. To illustrate the hierarchical nature of the outline, subordinate outline elements are indented relative to their parents. Accompanying each outline element in the list is a length identifier and a notes indicator. The length identifier specifies the length, in minutes and seconds, of that portion of the multimedia program. The notes indicator comprises a flag which specifies whether the end user has entered any notes for that particular outline element. Where notes are available (because they have been entered by the end user), a notes flag may be displayed with the outline element. As described in more detail below, in certain embodiments, end users may share notes via an on-line learning community. In such embodiments, the notes indicator may be used to indicate where shared notes are available for a particular outline element.

The resources pane comprises four alternating tabs corresponding to respective research tools. In the “articles” tab (FIG. 6), an index of terms is displayed which link to resources, such as definitions, articles, documents, etc.

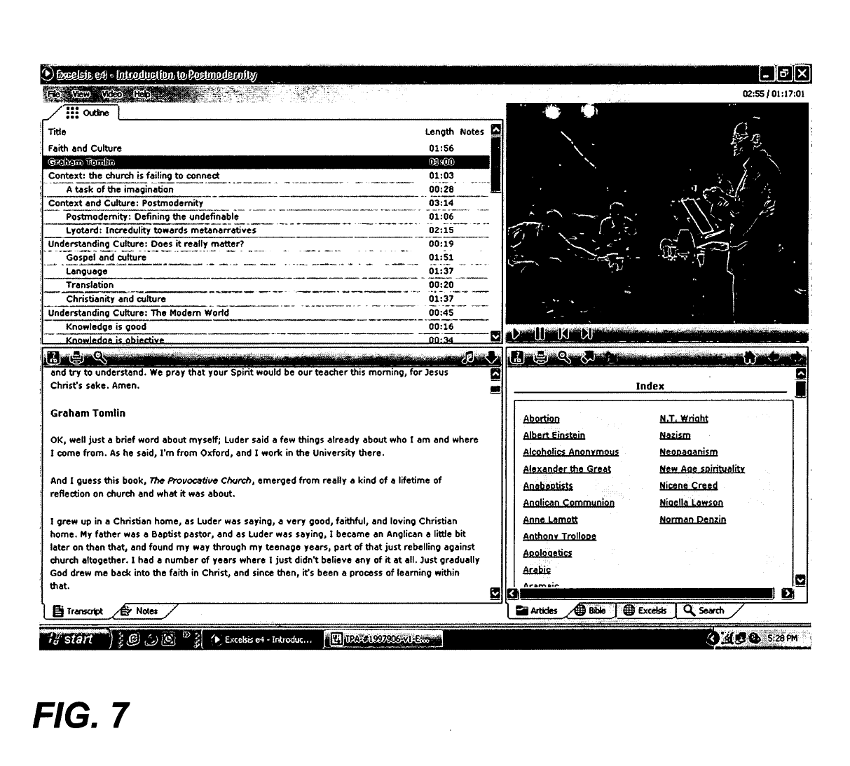

As mentioned above, each pane may include a control layer for enabling the end user to navigate the content of the multimedia program. In the screen shot of FIG. 7, the end user accesses the control layer for the A/V pane by moving the mouse cursor over a portion of the pane. In this embodiment, the A/V control layer comprises a media navigation toolbar which includes a play video command, a pause video command, a rewind video command, and a fast-forward video command. If the end user initiates any of these commands, MNSF 102 receives the command from the A/V pane and synchronously updates the content in the outline pane and the transcript pane.

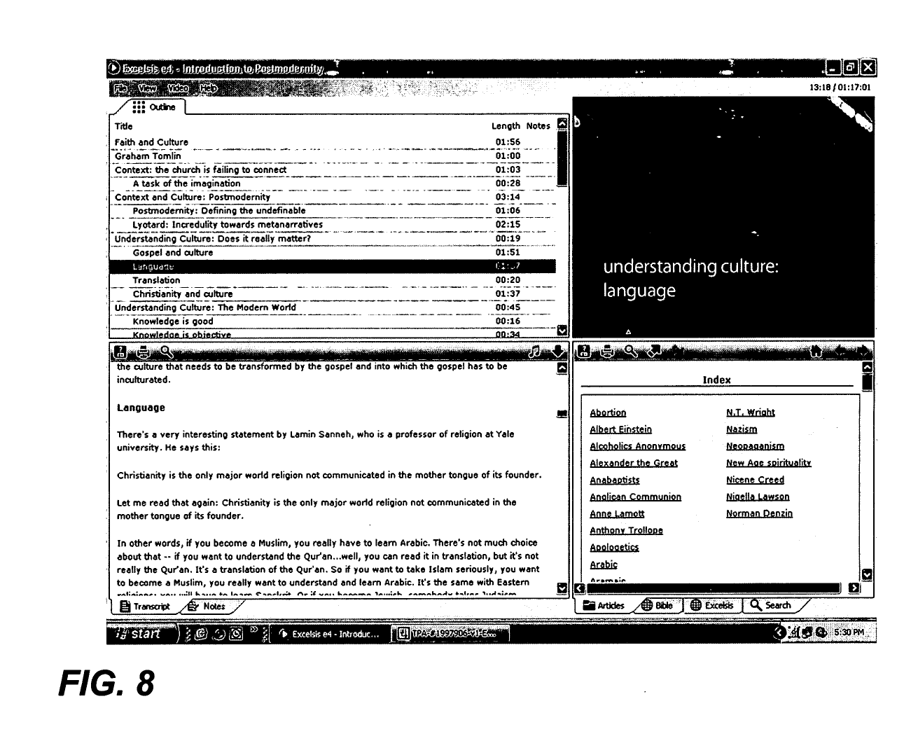

The screen shot of FIG. 8 illustrates an embodiment of a control layer for the outline pane. The end user may navigate through the multimedia program by selecting the outlines elements. In FIG. 8, the end user has selected the “Language” outline element and, in response, MNSF 102 has updated the transcript pane to display the corresponding portion of the transcript under the heading “Language.” As mentioned above, the temporal link between the outline pane and the transcript pane may be provided by time stamps 312 in annotated transcript 304. Similarly, the video displayed in A/V pane has been moved to the video frame entitled “understanding culture: language.”

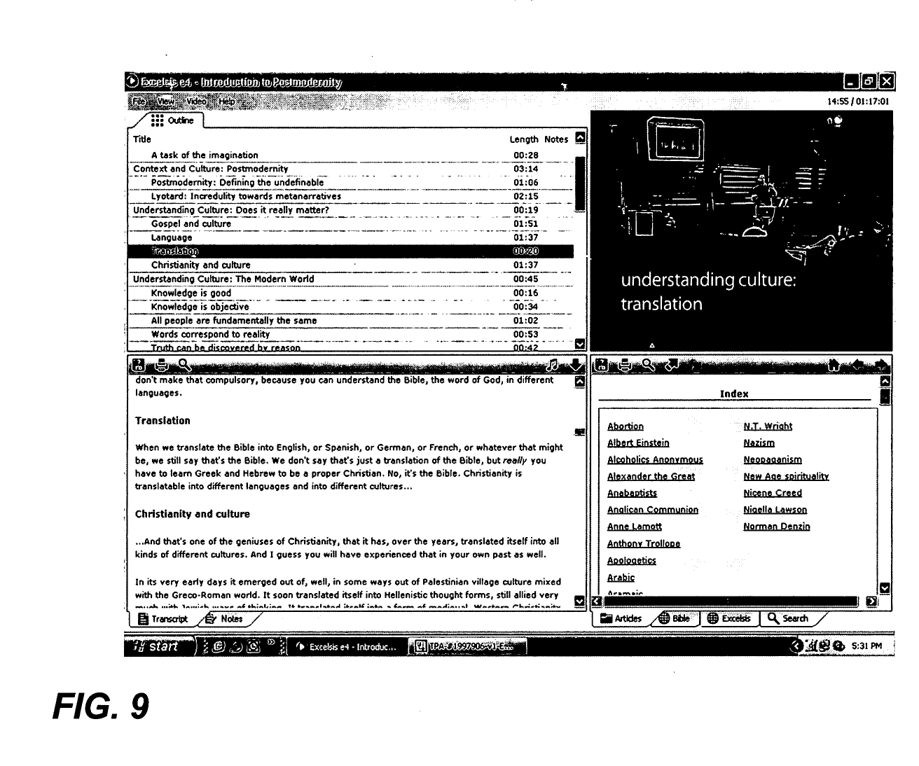

As illustrated in the screen shot of FIG. 9, the transcript pane may be enhanced with a text framing feature. The text framing feature highlights the appropriate text in the transcript pane as the video is played to aid the end user in following the content.

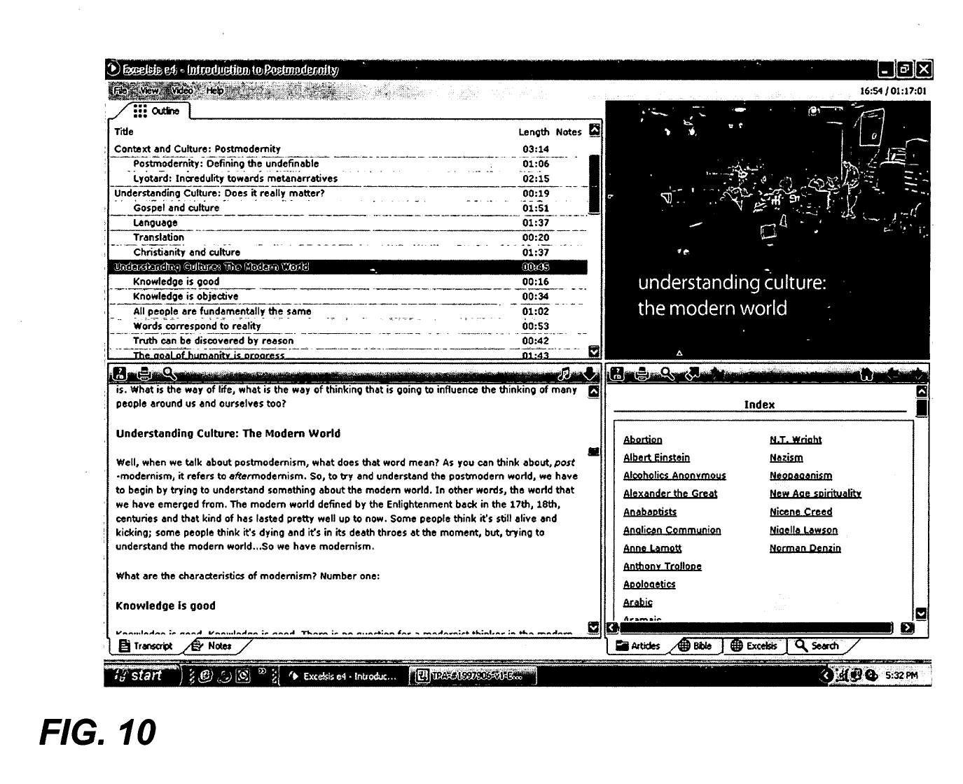

The screen shot of FIG. 10 illustrates an embodiment of a control layer for the transcript pane. The end user may navigate within the transcript pane be selecting hypertext-linked headings. In FIG. 10, the user has selected the heading entitled “Understanding Culture: The Modern World” and, in response, MNSF 102 has updated the outline pane (by highlighting the outline element of the same name) and the video pane by moving to the corresponding video frame.

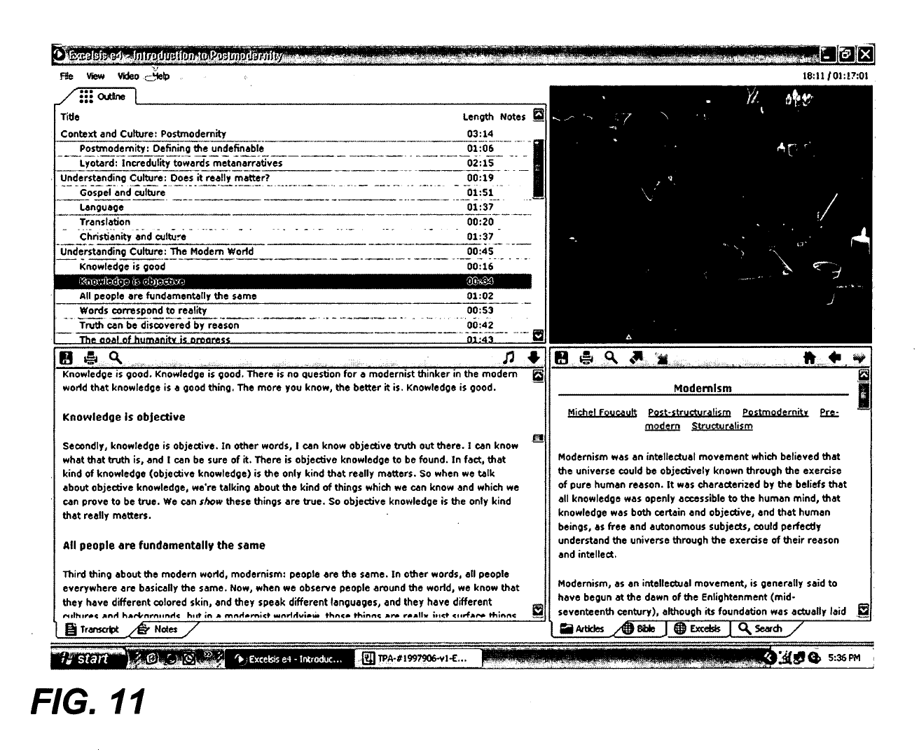

The screen shot of FIG. 11 illustrates one of the resource features provided via the resource pane. Significant keywords, terms, or themes are highlighted in the transcript pane, and hypertext links are created to corresponding resources in knowledge base 512. When the end user selects the links in the transcript pane, the corresponding resources are displayed in the resource pane. The user may pause the video in the A/V pane and explore any of the links in the resources pane. The resources presented in the resources pane may also be hypertext linked to further resources. This feature of the resources pane may be configured much like a web browser and may lead to any on-line resources, such as the purchase of related books, affiliated web sites, etc.

In FIG. 11, the end user has selected the hypertext link corresponding to the term “modernism” and the resource pane has been populated with appropriate resources related to this topic.

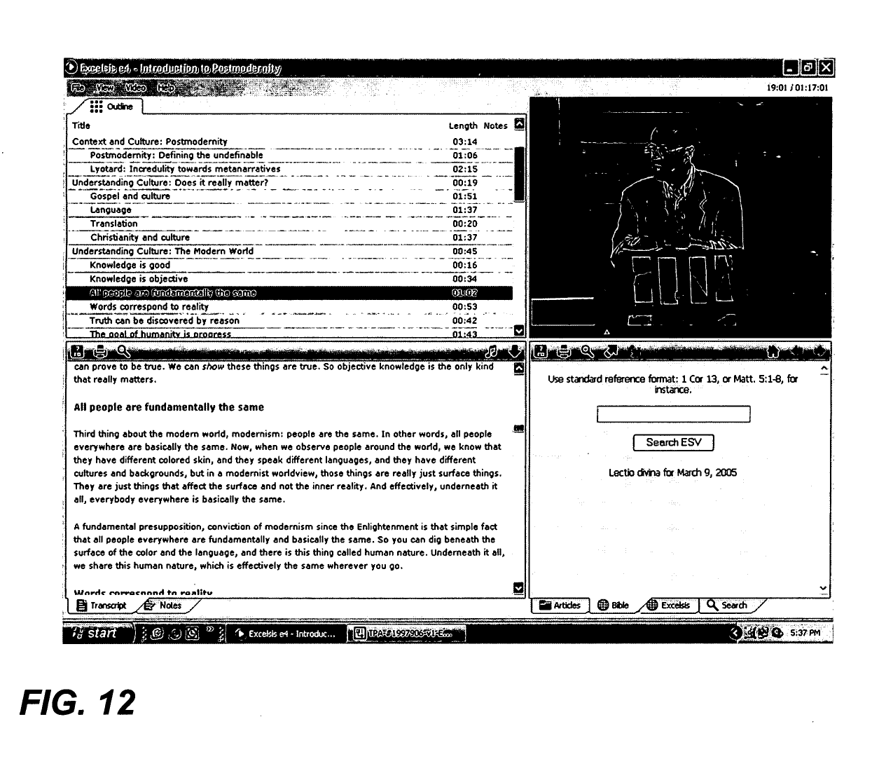

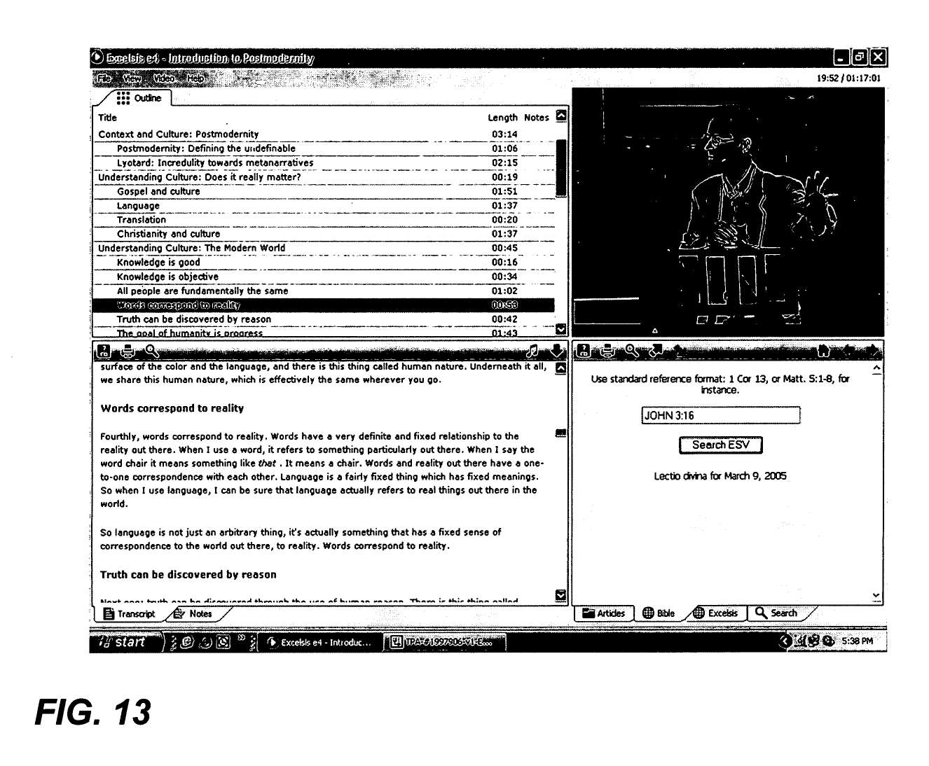

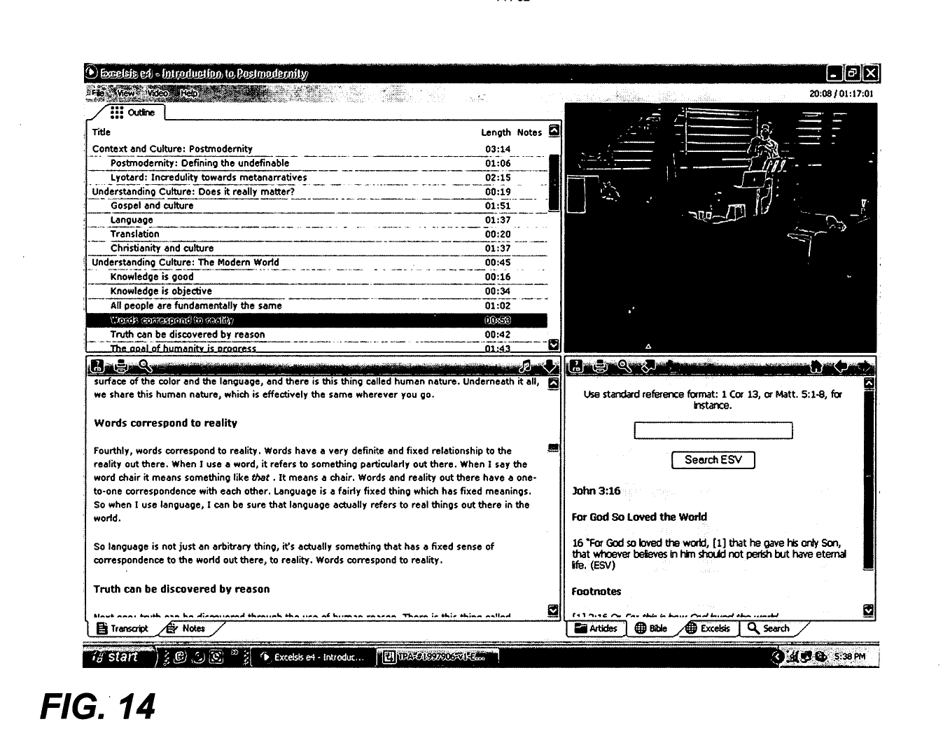

The screen shots of FIGS. 12-14 illustrate another resource provided via the resources pane—a reference look-up accessed via another tab. In FIG. 12, the reference is the Bible and the look-up feature enables the end user to enter a Bible verse using standard chapter-verse notation. In FIG. 13, the end user has entered “JOHN 3:16” in a text box. In FIG. 14, the corresponding passage obtained from the knowledge base is displayed in the resources pane.

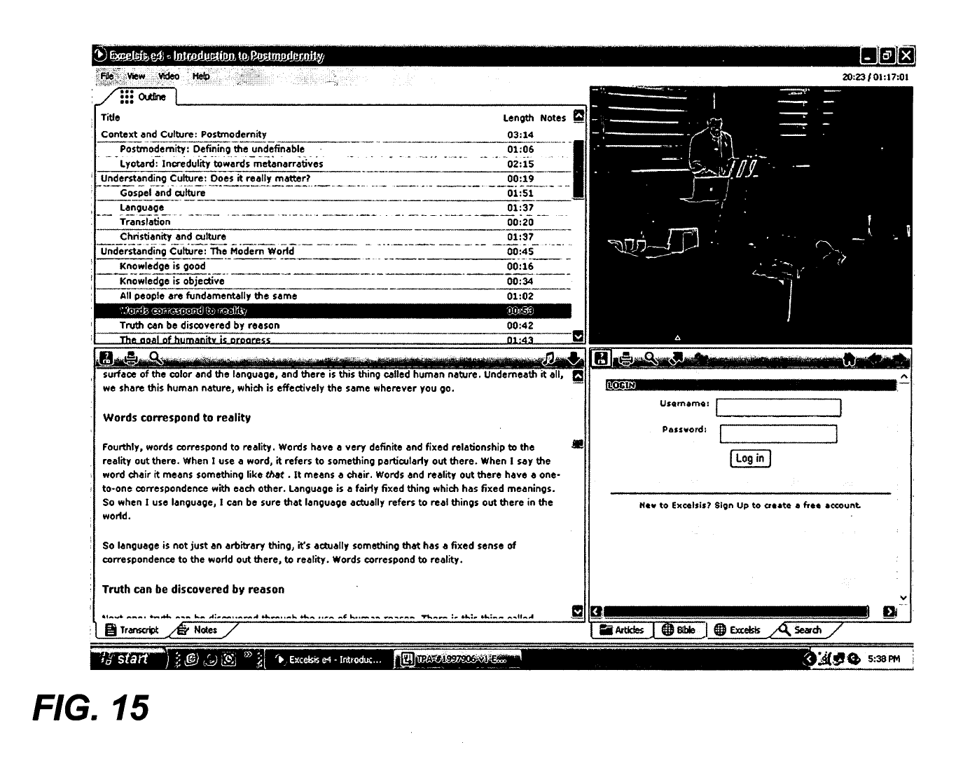

The screen shot of FIG. 15 illustrates another resource provided via the resources pane—a log-in screen for accessing an on-line resource. The log-in screen is accessed by selecting another of the tabs in the resource pane. The end user may input a username and a password to access the on-line resource. If the end user is authorized, access is provided to the on-line resource. The on-line resource may be provided via the resources pane or via another window or application.

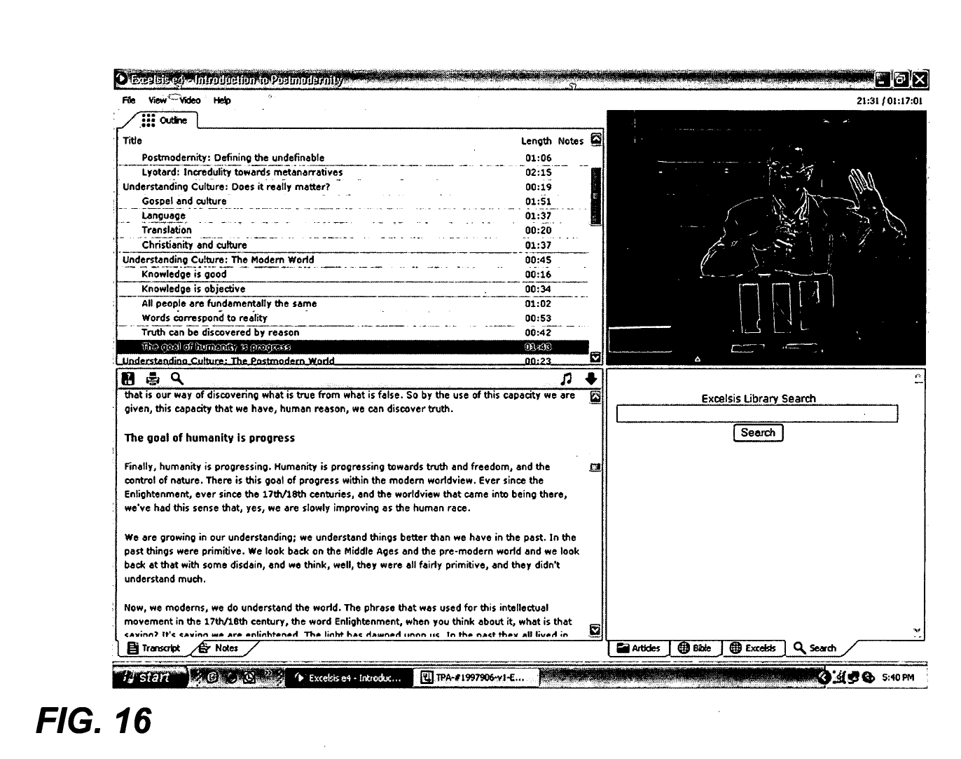

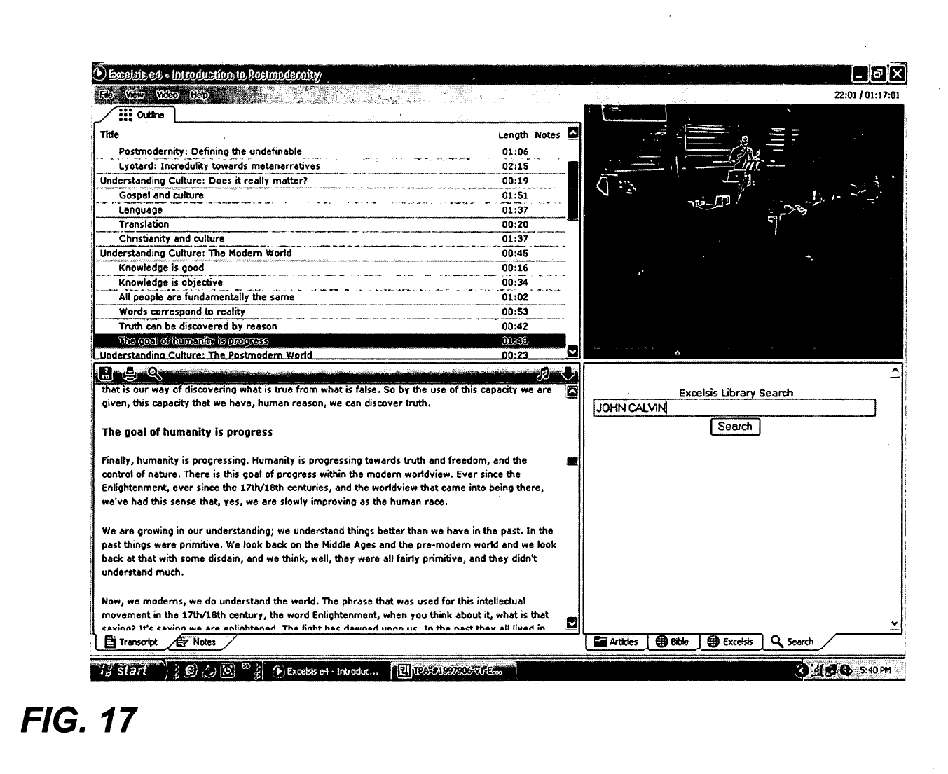

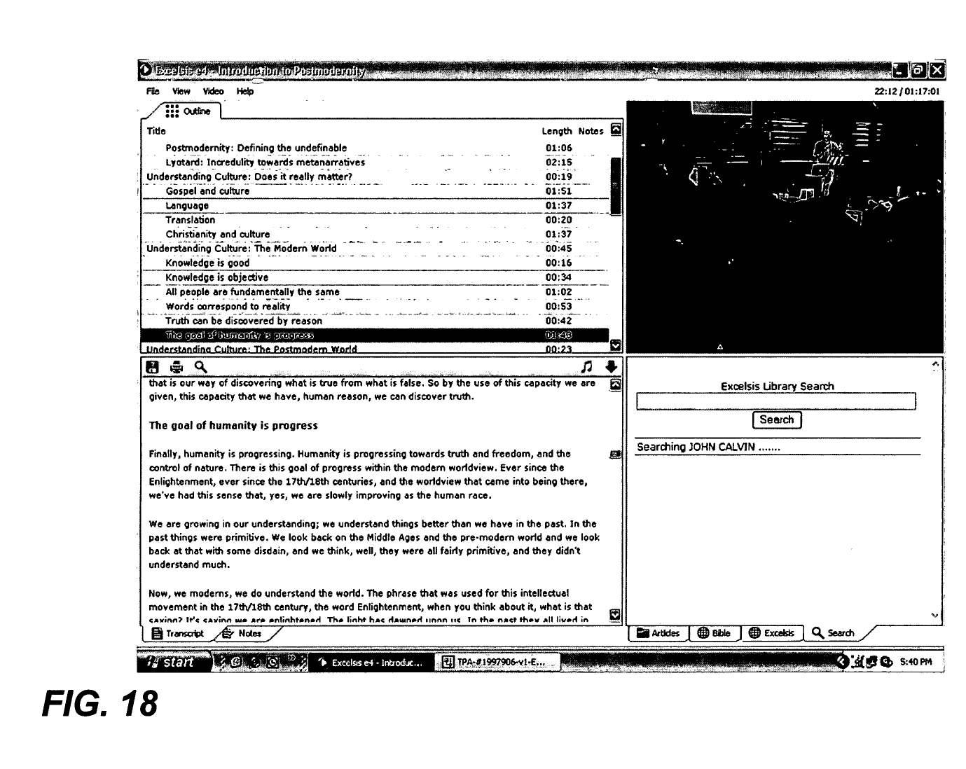

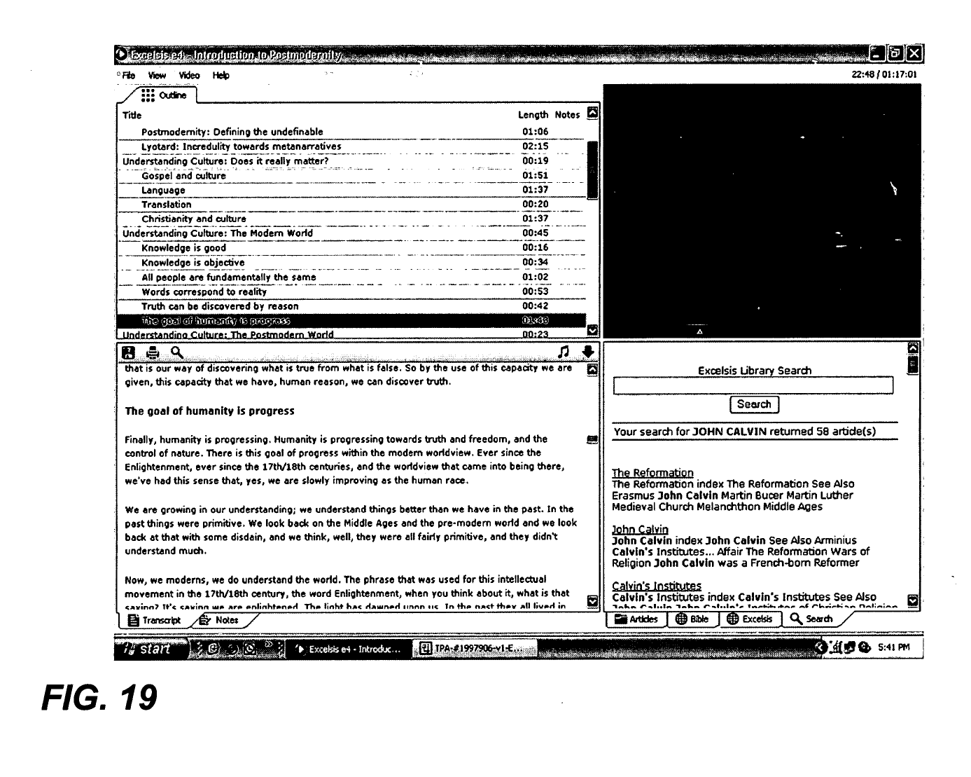

The screen shots of FIGS. 16-19 illustrate a library search resource which may be accessed via a “search” tab provided in the resources pane. The library search may employ a local database or a remote database. In FIG. 17, the end user has entered the search terms “JOHN CALVIN” in the search text box. As illustrated in FIG. 18, the database is queried and, in FIG. 19, the search results are displayed in the resources pane.

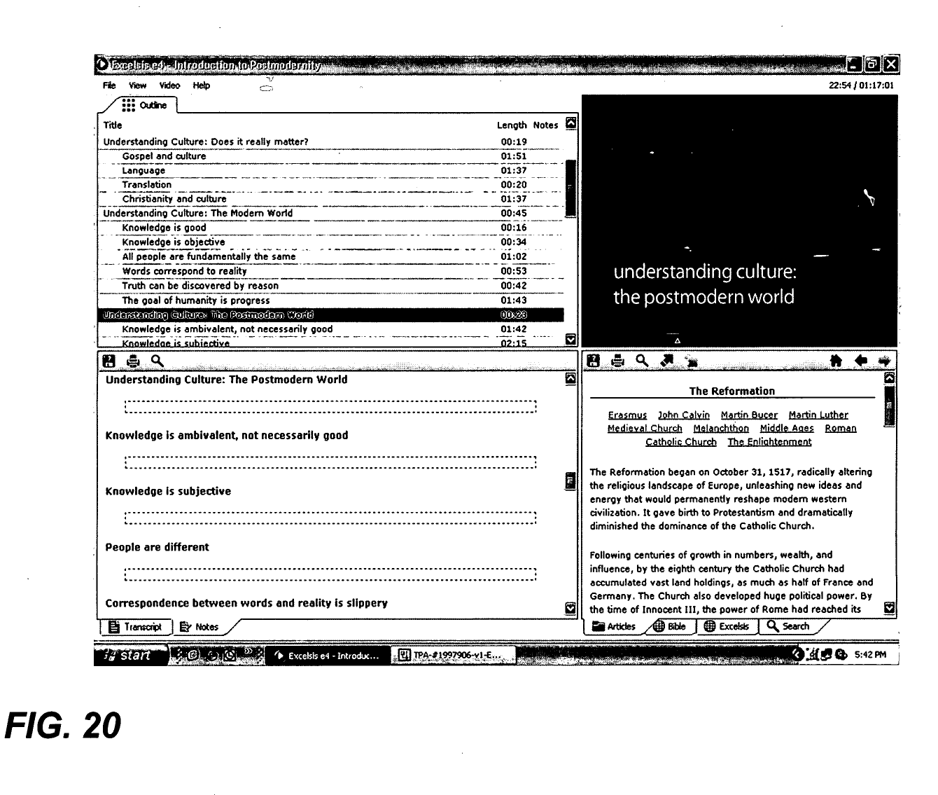

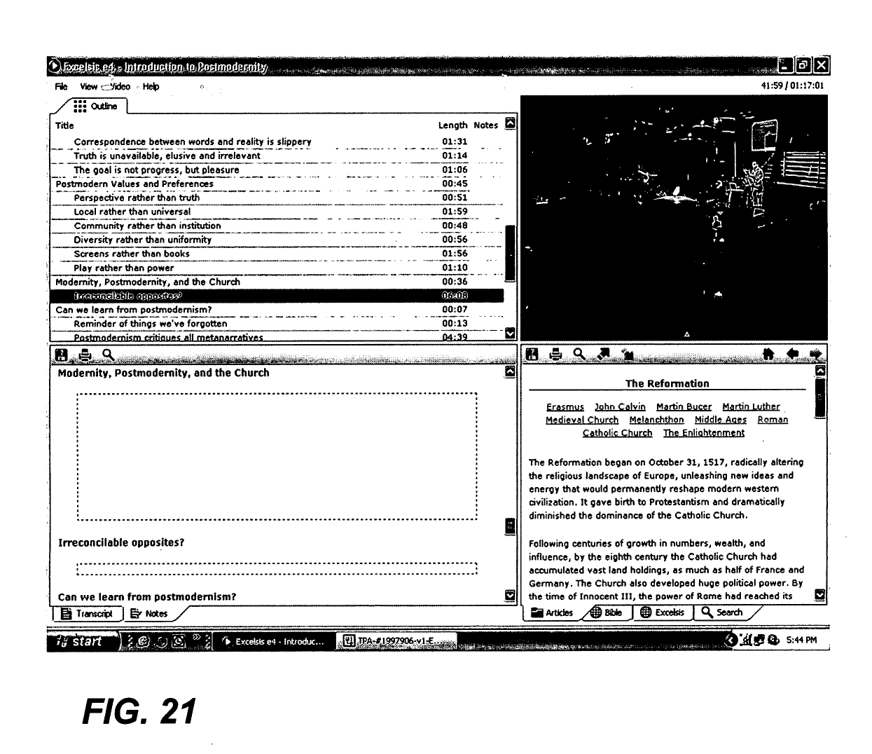

FIGS. 20 and 21 illustrate a notepad functionality accessed via the “notes” tab associated with the transcript pane. The notepad functionality enables the end user to contemporaneously enter notes while viewing the multimedia program. The notes may be stored and linked with the appropriate portions of the multimedia program. As illustrated in FIG. 20, the notepad functionality may be arranged in accordance with the outline structure, as a series of outline headings and corresponding text boxes for entering notes. As illustrated in FIG. 21, the text boxes may be manipulated in much the same manner as a word processing-type application.

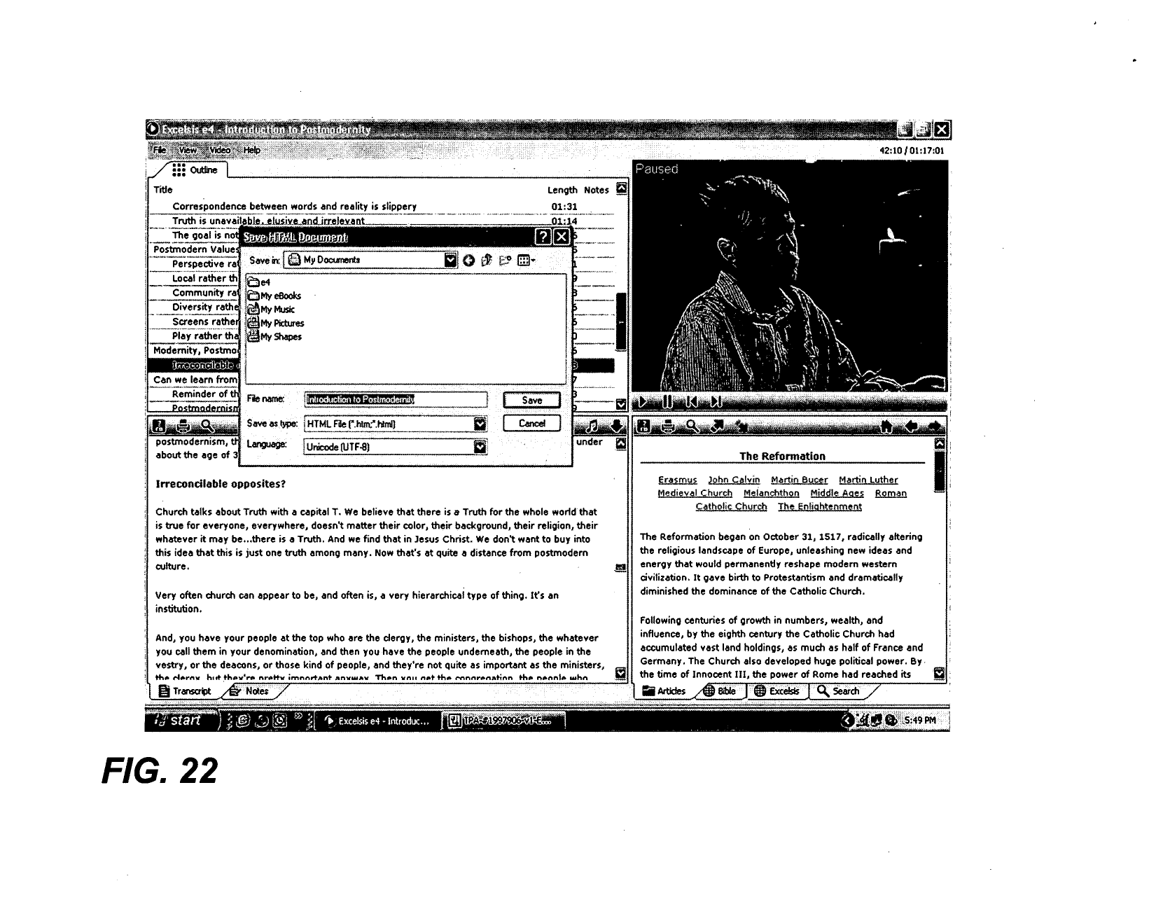

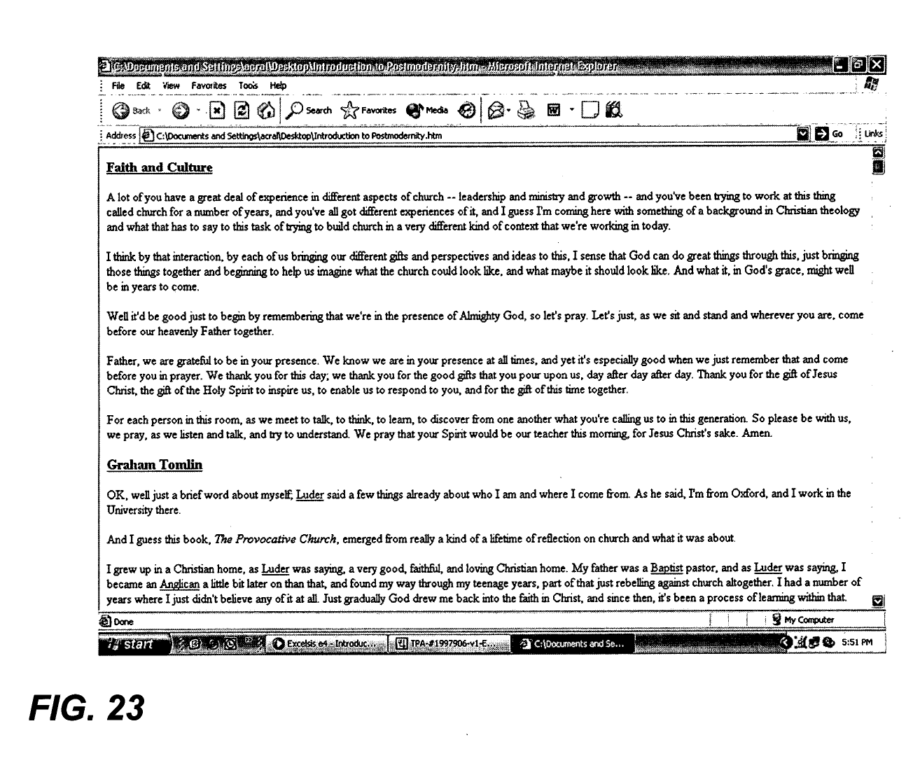

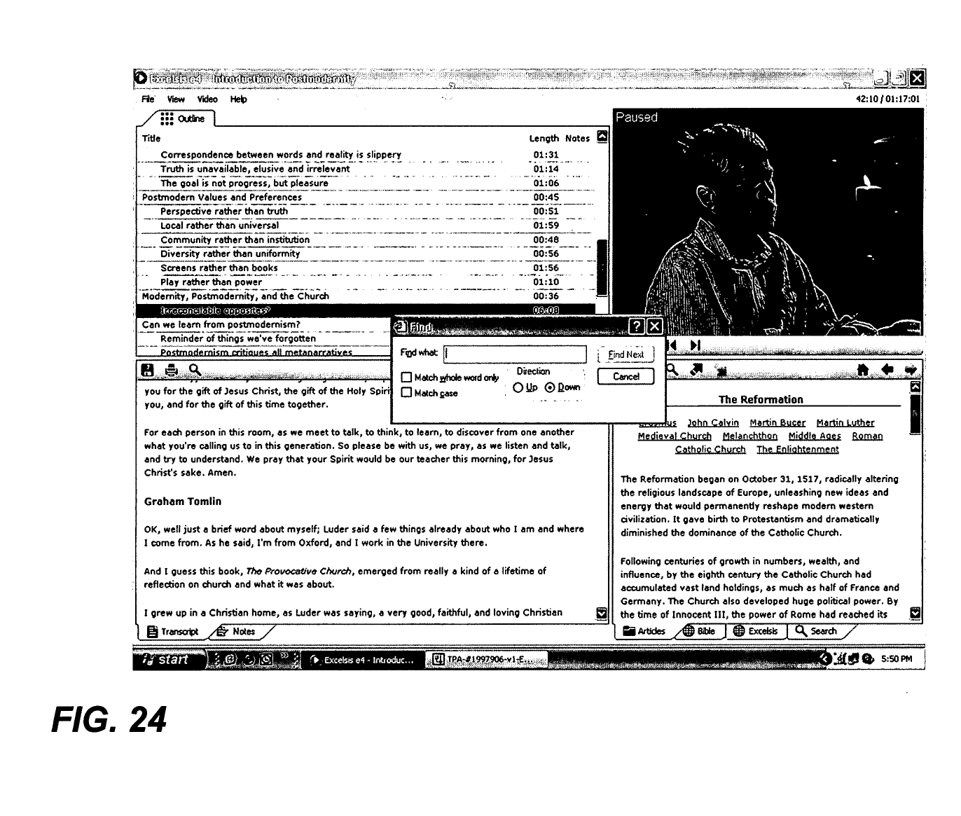

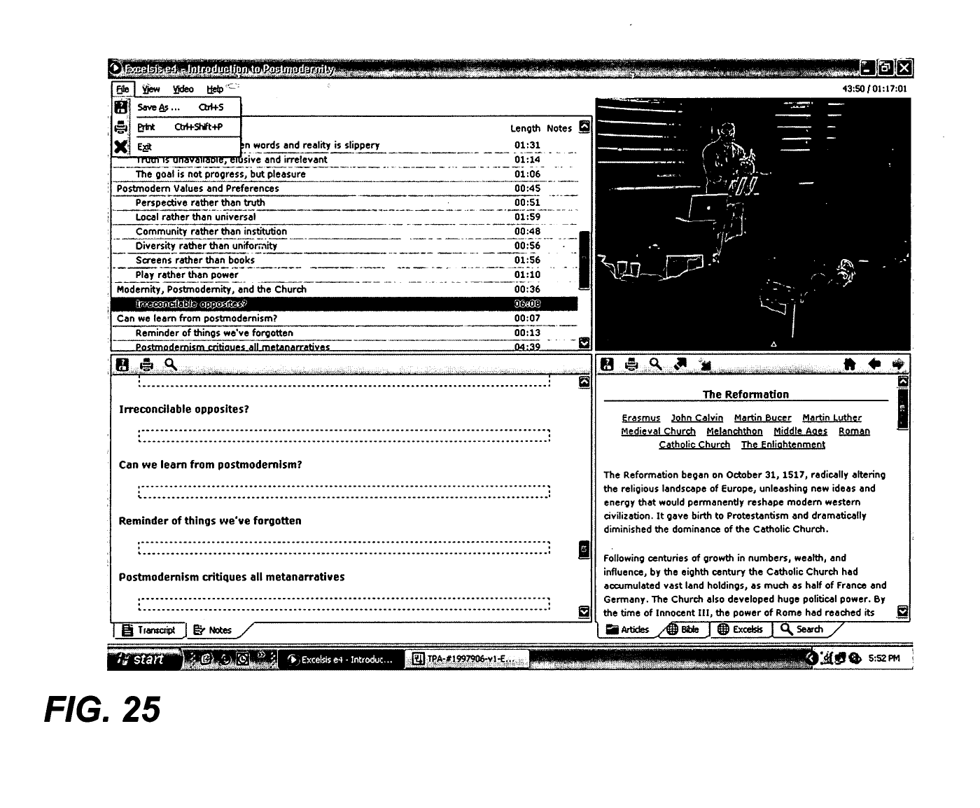

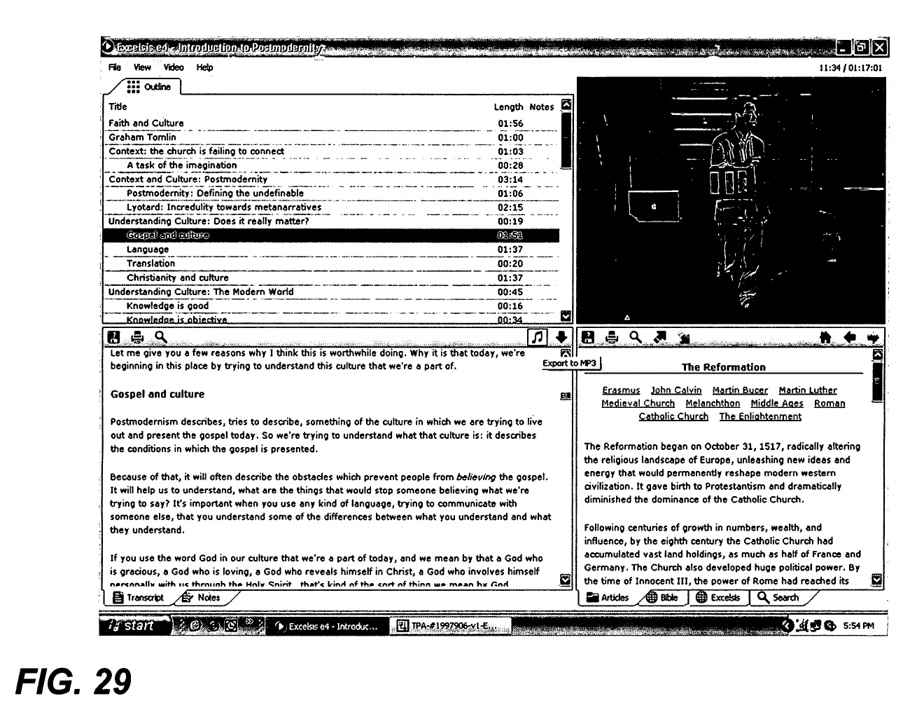

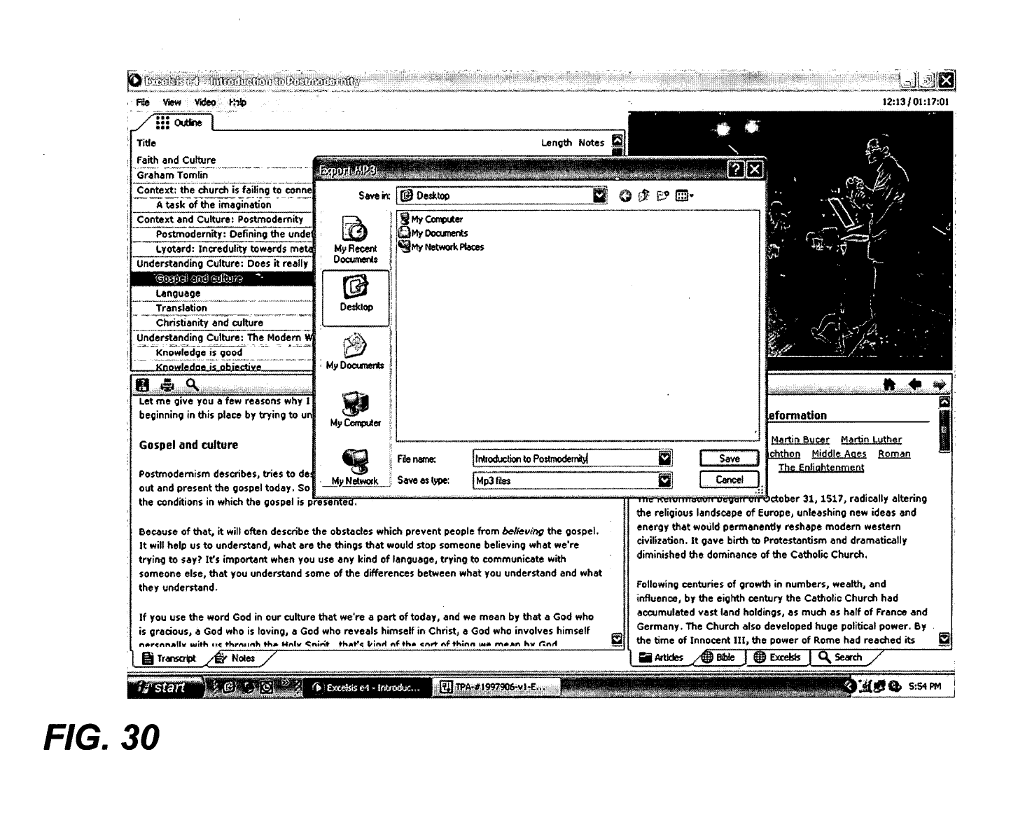

Additional features of the user interface are illustrated in FIGS. 22-30. As illustrated in the screen shots of FIG. 22 and 23, the end user may save the transcript to a file, such as an HTML file (FIG. 23). The screen shot of FIG. 24 illustrates a search functionality which enables the end user to search the contents of the transcript pane. FIGS. 25-28 illustrate various menu options provided via an applications toolbar. As illustrated in FIGS. 29 and 30, the end user may export the audio portion of the video to a file, such as an MP3, for subsequent listening.

As mentioned above, MNSF 102 may enable the computer end user to spontaneously enter notes into a notes pane while viewing and interacting with the multimedia program. The entered notes may be stored with the other content of the multimedia program. The entered notes may be synchronized relative the other portions of the multimedia program. For instance, within the context of a particular outline heading, the computer end user may record some thoughts. These notes may be temporally linked or otherwise associated with the outline heading, so that the notes are synchronously presented with the outline heading (and the corresponding portions of the transcript and the A/V data). As described above, the outline pane may include a note flag next to outline headings or elements in which the computer end user has entered notes.

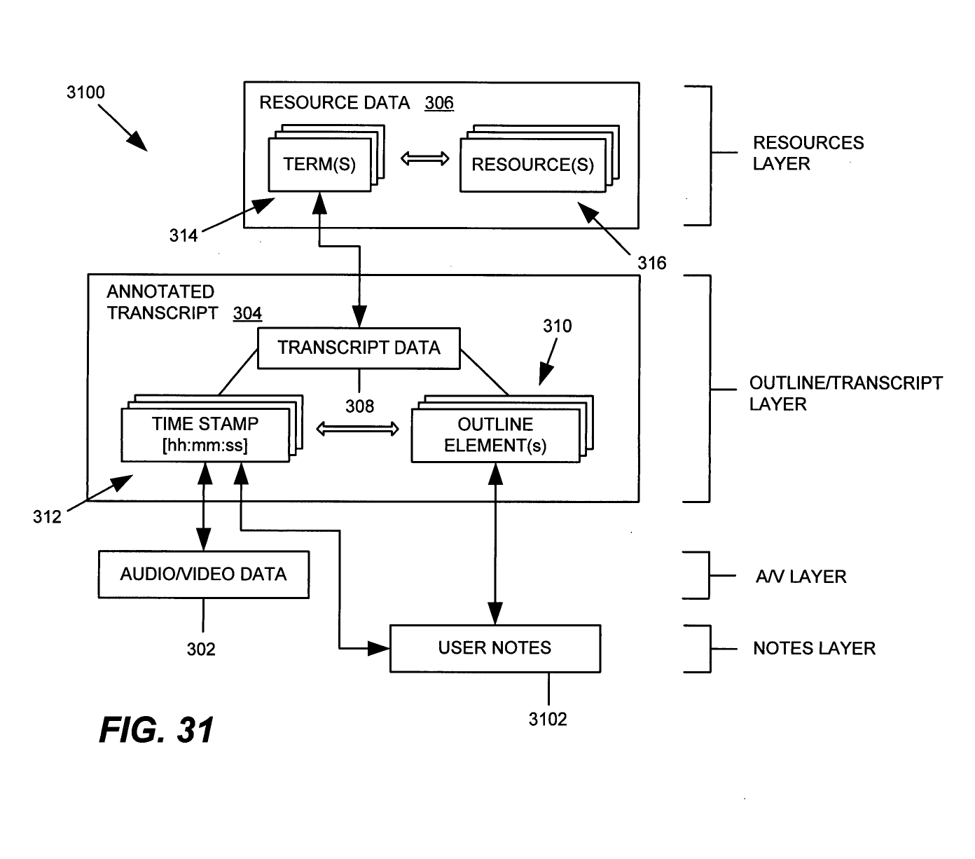

It should be appreciated that the notes may be integrated with the multimedia program. FIG. 31 illustrates the logical data structure for an integrated multimedia program 3100 which includes the user's notes. Integrated multimedia program 3100 is configured in much the same manner as the multimedia program illustrated in FIG. 3. However, integrated multimedia program 3100 adds a notes layer to the resources layer, A/V layer, and the outline/transcript layer. The notes layer comprises data representing user notes 3102 entered via the notes pane. As illustrated in FIG. 31, user notes 3102 may be linked to the other aspects of the multimedia program via time stamp data 312 and/or outline elements 310. As the computer end user enters notes while viewing the multimedia program, MNSF 102 may automatically capture an appropriate time stamp which is used to synchronize the notes to the transcript, the outline, and the A/V data. MNSF 102 may also be configured to enable the user to specify the manner in which the notes are to be associated with the multimedia program.

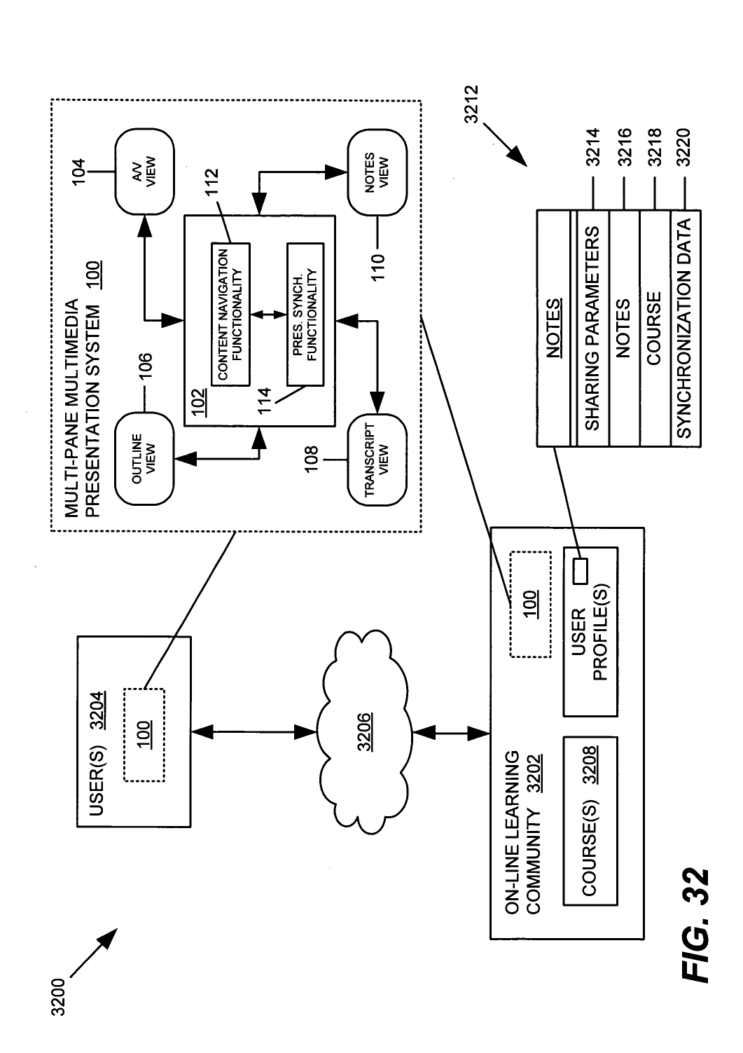

The multimedia programs described above may be distributed to computer end users in any suitable manner. In one of a number of possible embodiments, the multimedia programs are distributed to computer end users via a suitable computer network (e.g., the Internet, other wide area network, a local area network, etc.). FIG. 32 illustrates an embodiment of a content distribution system 3200 in which the multimedia programs are distributed to computer end users 3204 from an on-line learning community 3203 via a computer network 3206. As illustrated in FIG. 32, various aspects of multimedia presentation system 100 (and MNSF 102) may be distributed between on-line learning community 3202 and the user's computer system.

On-line learning community 3202 may store the multimedia programs as various courses 3208 involving any topic of interest. On-line learning community 3202 may also store user profiles for each registered computer end user 3204. The user profiles may store various forms of customer information, preferences, etc. The user profiles may also store information about which courses 3208 the user has purchased, licensed, etc.

On-line learning community 3202 may also support a notes publication functionality which enables computer end users 3204 to publish their notes for a particular course 3208 to on-line learning community 3202. As mentioned above, an end user 3204 may spontaneously enter notes while viewing a particular multimedia program presented via MNSF 102. MNSF 102 may be configured to publish the notes to on-line learning community 3202 in, for example, an XML format. On-line learning community 3202 may synchronize the notes with the notes the user has previously published—whether through an on-line client or a desktop client. The synchronized data is returned to MNSF 102, and the user sees the synchronized notes show up in the software.

On-line learning community 3202 also allows end users 3204 to create groups of “friends”; or become part of multiple groups. In this regard, the user profiles may include notes sharing data 3212 which may include, for example, sharing parameters data 3214, notes data 3216, course data 3218, and synchronization data 3220. When the user publishes their notes, on-line learning community 3202 pulls together the notes of all their friends, organizes it, and sends it back to the client.

It should be appreciated that the process and logical descriptions of multimedia presentation system 100 and MNSF 102 may represent modules, segments, or portions of code which include one or more executable instructions for implementing specific logical functions or steps in a process. It should be further appreciated that any logical functions may be executed out of order from that shown or discussed, including substantially concurrently or in reverse order, depending on the functionality involved, as would be understood by those reasonably skilled in the art.

Furthermore, multimedia presentation system 100 and MNSF 102 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Although this disclosure describes the invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A computer system for presenting a multimedia program to a user via a user interface, the computer system comprising:
a video pane for presenting a video portion of a multimedia program on a first portion of a user interface;
a transcript pane for presenting a transcript of the video portion on a second portion of the user interface;
an outline pane for presenting an outline of the multimedia program on a third portion of the user interface; and
a presentation synchronization functionality configured to synchronously present the video portion, the transcript, and the outline.

2. The computer system of claim 1, further comprising a content navigation functionality comprising:
logic configured to receive a content navigation command from at least one of the video pane, the transcript pane, and the outline pane; and
logic configured to synchronously update the content presented in the video portion, the transcript, and the outline based on the content navigation command.

3. The computer system of claim 2, wherein the video pane comprises a video playback controller in communication with the content navigation module.

4. The computer system of claim 1, wherein the presentation synchronization functionality is configured to receive a content navigation command from the video pane, the transcript pane, and the outline pane.

5. The computer system of claim 1, further comprising a notes pane configured to enable a user to input notes associated with the multimedia program.

6. The computer system of claim 5, wherein the notes pane is triggered via a tab associated with the transcript pane.

7. The computer system of claim 5, wherein the notes input in the notes pane are timestamped relative to the multimedia program.

8. The computer system of claim 7, wherein the presentation synchronization functionality synchronously presents the notes in the notes pane with at least one of the video portion, the transcript, and the outline.

9. The computer system of claim 1, further comprising a resources pane for presenting recourses associated with multimedia program on a fourth portion of the user interface.

10. The computer system of claim 9, wherein the resources pane interfaces with a resource index which associates terms from the transcript with corresponding resources.

11. The computer system of claim 10, wherein the resources pane provides a search facility.

12. A method for presenting a multimedia program to a user via a graphical user interface, the method comprising:
receiving a multimedia program comprising a video portion, a transcript of the video portion, and an outline of the multimedia program; and
synchronously presenting the video portion, the transcript, and the outline in respective panes of a user interface.

13. A multimedia presentation embodied in a computer-readable medium and configured for presentation to a user via a graphical user interface, the multimedia presentation comprising:
media data; and
a transcript of the media data comprising:
a plurality of outline elements defining an outline schema associated with the content of the media data; and
a plurality of timestamps synchronized to the corresponding portions of the media data.

14. The multimedia presentation of claim 13, wherein the media data comprises an audio/video file.

15. The multimedia presentation of claim 13, wherein the transcript comprises an XML file and the outline elements and the timestamps comprise XML tags.

16. The multimedia presentation of claim 13, further comprising user-defined notes synchronized to the corresponding portions of the media data or the outline schema.

17. The multimedia presentation of claim 13, further comprising an index of resource data which associates a plurality of terms in the transcript to corresponding resources.

18. A method for creating a multimedia presentation, the method comprising:
providing audio data of an oral presentation;
generating a transcript of the oral presentation;
generating an outline of the oral presentation; and
synchronizing the transcript, the outline, and the audio data for simultaneous presentation in a transcript pane, an outline pane, and an audio pane of a user interface.

19. The method of claim 18, wherein the audio data comprises video.

20. The method of claim 18, further comprising presenting a resource pane in the user interface with the transcript pane, the outline pane, and the audio pane.

21. The method of claim 20, further comprising indexing the transcript to link a plurality of terms to corresponding resources.

22. The method of claim 20, wherein a portion of the terms comprises hypertext links to the corresponding resources,

23. The method of claim 18, further comprising providing a notes pane in the user interface to enable a user to input notes.

24. The method of claim 23, wherein the notes are synchronized with the transcript, the outline, and the audio data.

25. The method of claim 18, wherein the transcript and the outline are implemented in an XML file which is tagged with a plurality of timestamps for synchronizing the transcript with the audio data and a plurality of outline elements for synchronizing the outline with the audio data.

26. The method of claim 18, wherein the outline comprises a plurality of outline elements and the transcript is annotated with the outline elements.

27. The method of claim 18, further comprising navigating the multimedia presentation via a navigation functionality provided in at least one of the transcript pane, the outline pane, and the audio pane.

28. The method of claim 27, further comprising synchronously presenting the transcript, the outline, and the audio data in response to the navigating the multimedia presentation.

29. A method for presenting a multimedia presentation in an interactive user interface, the method comprising:
presenting a multimedia program in a first pane, a second pane, and a third pane of a user interface, the first pane for presenting video data associated with the multimedia program, the second pane for presenting an outline of the multimedia program, and the third pane for presenting a transcript of the video data; and
enabling a user to synchronously navigate the multimedia program from each of the transcript pane, the video pane, and the outline pane.

30. The method of claim 29, wherein the enabling a user to synchronously navigate the multimedia program from each of the transcript pane, the video pane, and the outline pane comprises:
providing a content navigation functionality for each of the transcript pane, the video pane, and the outline pane;
receiving a content navigation command from the content navigation functionality associated with one of the transcript pane, the video pane, and the outline pane; and
updating the presentation of the video data, the transcript, and the outline based on the content navigation command.

31. The method of claim 30, wherein the content navigation command defines a new temporal location associated with the multimedia program.

32. The method of claim 30, wherein the content navigation functionality associated with the video pane comprises a video navigation controller.

33. The method of claim 30, wherein the content navigation functionality associated with the outline pane comprises a plurality of outline elements associated with a corresponding timestamp of the video data.

34. The method of claim 30, wherein the content navigation functionality associated with the transcript pane comprises a plurality of timestamped links.

35. A computer system for presenting a multimedia program, the computer system comprising:
a user interface comprising: a video pane for presenting a video portion of a multimedia program; a transcript pane for presenting a transcript of the video portion, and an outline pane for presenting an outline of the multimedia program;
a multi-pane navigation/synchronization module configured to enable a user to synchronously navigate the multimedia program via at least one of the transcript pane, the video pane, and the outline pane.

36. The computer system of claim 35, wherein the multi-pane navigation/synchronization module employs an annotated transcript file which interfaces with the outline pane and the transcript pane.

37. The computer system of claim 36, wherein the annotated transcript file comprises transcript data, a plurality of outline elements linked to the outline pane, and a plurality of timestamp elements linked to the video portion.

38. The computer system of claim 35, wherein the outline pane comprises a plurality of outline elements linked to corresponding timestamps.

39. The computer system of claim 35, wherein the transcript pane comprises a plurality of time-stamped text links.

40. The computer system of claim 35, wherein the video pane comprises a video control toolbar.
